(19) United States
(12) Patent Application Publication
(10) Pub. No.: US 2017/0024245 A1
(43) Pub. Date: Jan. 26, 2017

(54) WORKLOAD-AWARE SHARED PROCESSING OF MAP-REDUCE JOBS

(71) Applicant: Hitachi, Ltd., Tokyo (JP)

(72) Inventors: Wei Xiang GOH, Singapore (SG); Wujuan LIN, Singapore (SG); Rajesh Vellore ARUMUGAM, Singapore (SG)

(21) Appl. No.: 14/807,930

(22) Filed: Jul. 24, 2015

(51) Int. Cl. G06F 9/48; G06F 9/50

(52) U.S. Cl. CPC G06F 9/4843; G06F 9/5027

(57) ABSTRACT

Some examples include a plurality of nodes configured to execute map-reduce jobs by enabling tasks to share processing slots with other tasks. As one example, a job tracker may compare a task profile for a received task with one or more task profiles for one or more respective tasks already assigned for execution on the processing slots of one or more worker nodes. Based at least in part on the comparing, the job tracker may select a particular one of already assigned tasks to be executed concurrently with the received task on a slot. In addition, the job tracker may determine one or more expected future tasks based at least in part on one or more ongoing workflows of map-reduce jobs. The selection of the already assigned task to be executed concurrently with the received task may also be based in part on the expected future tasks.

### BACKGROUND

A map-reduce framework and/or similar parallel processing paradigms may be used for batch analysis of large amounts of data. For example, some map-reduce frameworks may employ a plurality of worker node computing devices that process data for a map-reduce job. A workflow configuration may be used to direct the map-reduce jobs through the worker nodes, such as by assigning particular map tasks or reduce tasks to particular worker nodes.

While the map-reduce framework was initially designed for large batch processing, modern industrial usage of map-reduce typically employs the map-reduce framework for a wide variety of jobs, varying in input sizes, processing times and priorities. Furthermore, there is a trend toward pooling the physical resources (i.e., physical machines) into a single shared map-reduce cluster because maintaining multiple local clusters tends to result in underutilization of resources. These trends have the potential to cause resource contention and difficulty in enforcing priorities due to both shared usage and mixed job profiles. As one consequence, there may not be enough available processing slots to run the tasks of a high priority job (i.e., having a plurality of prioritized tasks) in a desired or necessary amount of time. Such a situation may starve the higher priority job and may result in lack of adherence to a service-level objective.

### SUMMARY

In some implementations, an incoming higher priority task may be scheduled to share a task processing slot with a lower priority task already assigned to the slot. For instance, the worker nodes may be configured to accept multiple task assignments for the same slot. Further, the worker nodes may identify which map or reduce functions to process based on the priority associated with each task and the availability of the respective input/output (I/O) for each function. Task profiling may be performed to obtain task characteristics to enable selection of optimal tasks for sharing slots. In addition, one or more expected future tasks may be determined based at least in part on one or more currently executing ongoing workflows of map-reduce jobs. The selection of a slot be shared by the incoming task may also be determined based in part on the task profiles of the expected future tasks

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example system architecture for workload-aware shared processing of map-reduce jobs according to some implementations.

FIG. 2 illustrates an example job tracker computing device according to some implementations.

FIG. 3 illustrates an example workflow learning database according to some implementations.

FIG. 4 illustrates an example worker node computing device according to some implementations.

FIG. 5 illustrates an example processing slot according to some implementations.

FIG. 6 is a flow diagram illustrating an example process for scheduling a job based at least in part on priority according to some implementations.

FIG. 7 illustrates an example task profile table according to some implementations.

FIG. 8 illustrates an example job profile table according to some implementations.

FIG. 9 is a flow diagram illustrating an example process for determining whether a received job corresponds to a workflow according to some implementations.

FIG. 10 illustrates an example current workflow table according to some implementations.

FIG. 11 illustrates an example job category table according to some implementations.

FIG. 12 illustrates an example identified workflow table according to some implementations.

FIG. 13 is a flow diagram illustrating an example process of selecting a slot for sharing a task according to some implementations.

FIG. 14 illustrates an example resource allocation table according to some implementations.

FIG. 15 is a flow diagram illustrating an example process for prediction of a future workload according to some implementations.

FIG. 16 illustrates an example of determining an optimal slot for sharing of a task according to some implementations.

FIG. 17 is a flow diagram illustrating an example process for execution of assigned tasks according to some implementations.

FIG. 18 illustrates an example buffer readiness table according to some implementations.

FIG. 19 illustrates an example task assignment table according to some implementations.

FIG. 20 illustrates an example user interface for visualizing and managing workflows according to some implementations.

FIG. 21 illustrates an example user interface for visualizing and managing jobs according to some implementations.

FIG. 22 is a flow diagram illustrating an example process for executing a received task according to some implementations.

### DETAILED DESCRIPTION

Some examples herein are directed to techniques and arrangements in which multiple map-reduce jobs may be concurrently managed and processed by enabling multiple tasks to share task processing slots. In the implementations herein, a task processing slot may be an abstraction, which indicates that certain quantities of computing resources are reserved for processing a task. For example, a plurality of computing devices referred to herein as worker nodes may each have one or more processors, and each processor may include one or more processing cores. In some cases, each worker node may be preconfigured to have a certain number of available task processing slots, e.g., based on the number of available processing cores and available memory. Furthermore, in some examples, the term “slot” may also encompass related concepts, such as the term “container” used in some map-reduce versions.

Some implementations may include prioritized processing of tasks by enabling a prioritized task to be assigned to and share the processing slot of a currently executing task. In other words, the resources associated with a single processing slot may be utilized for the concurrent processing of two or more tasks, such as a prioritized task and a non-prioritized task. This approach can enable adherence to a service-level objective without resorting to inefficient techniques such as task preemption or resource reservation. As one example, customized task trackers may be deployed on worker nodes to enable the processing of multiple tasks by the resources of a single slot according to an intelligent switching mechanism. In addition, the system may include workflow learning on map-reduce jobs to determine a prediction regarding future workload, such as to enable cluster-wide planning for slot sharing. Furthermore, the system may perform task profiling to aid in runtime decision making of task placement for slot sharing, and to provide updates to the machine learning, such as in the form of workflow learning on map-reduce jobs.

In some examples, an incoming higher priority task may be scheduled to share a task processing slot with an ongoing lower priority task already assigned to the slot and/or already being executed on the slot. For instance, a task tracker module on each worker node may be configured to accept multiple task assignments for the resources corresponding to a single slot. Further, the task tracker module may identify which map or reduce functions to process based on the priority associated with each task and the availability of the respective input and output for each function. Task profiling may be used to determine task characteristics associated with each task. By comparing the task profiles, the system may determine which task profiles complement each other sufficiently to enable selection of tasks that are optimal for sharing the same slot.

Further, workflow learning may be performed on submitted jobs to provide a prediction of the workload in the near future. For instance, the decision on which tasks to select for sharing a first slot affects the availability of other slots for sharing tasks that are received subsequently while the first slot is being shared. Thus, prediction of the workload can help avoid suboptimal placement of tasks into the same slots, when other tasks might be matched for sharing a slot to achieve greater overall efficiency. Accordingly, implementations herein employ task profiling and intelligent sharing placement, which can help avoid counterproductive results that may otherwise occur, e.g., due to resource contention within the same shared slot.

In addition, some examples may provide an administrator with tools to enable job management and/or altering of the workflow learning on map-reduce jobs. For instance, an administrator user interface many enable the administrator to view, analyze, and manage the workflow of the map-reduce cluster. Further, the administrator user interface may provide information regarding resource usage associated with particular jobs and/or tasks, and may enable the administrator to change parameters associated with the workflow learning and profile comparing.

For ease of understanding, some example implementations are described in the environment of a map-reduce cluster. However, implementations herein are not limited to the particular examples provided, and may be extended to other types of execution environments, other system architectures, other map-reduce configurations, and so forth, as will be apparent to those of skill in the art in light of the disclosure herein. Furthermore, while tables are used to describe example data structures herein, those of skill in the art will appreciate that any suitable type of data structure may be used for maintaining the data described in any of the example tables herein.

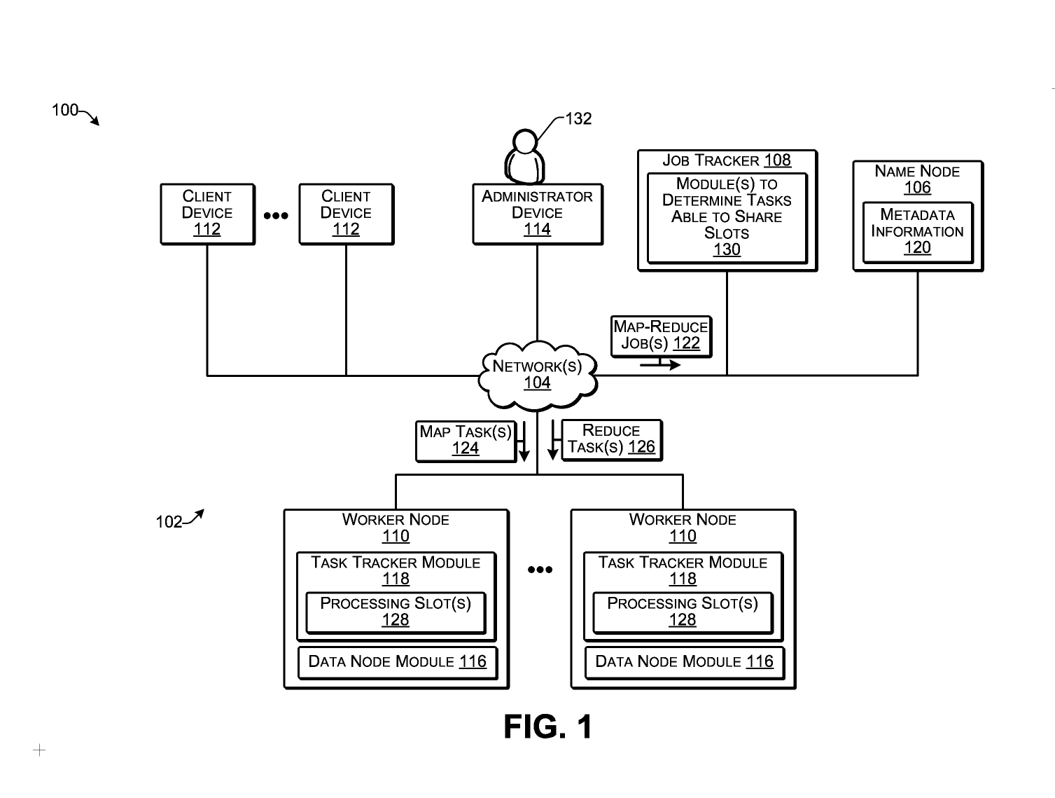

FIG. 1 illustrates an example architecture of a system 100 configured to execute a map-reduce framework with workload-aware shared processing according to some implementations. For instance, the system 100 may be able to execute multiple map-reduce jobs concurrently, as well as sequential and/or related map reduce jobs, such as to generate outputs for various types of large data sets. As one non-limiting example, the data to be analyzed may relate to a transit system, such as data regarding the relative movements and positions of a plurality of vehicles, e.g., trains, buses, or the like. Further, in some cases, it may be desirable for a large amount of data to be processed within a relatively short period of time, depending on the purpose of the analysis. Several additional non-limiting examples of data analysis that may be performed according to some implementations herein may include hospital patient management, just-in-time manufacturing, air traffic management, data warehouse optimization, information security management, business intelligence, and water control, to name a few.

The system 100 includes a plurality of computing devices 102 able to communicate with each other over one or more networks 104. The computing devices 102, which may also be referred to herein as nodes, may include a name node 106, a job tracker 108, a plurality of worker nodes 110, one or more client devices 112, and an administrator device 114 connected to the one or more networks 104. In some cases, the name node 106, the job tracker 108, and the plurality of worker nodes 110 may also be referred to as a cluster. Further, in some examples, the name node 106, the job tracker 108, and/or the administrator device 114 may located at the same physical computing device.

Each worker node 110 may include a data node module 116 and a task tracker module 118. The name node 106 may manage metadata information 120 corresponding to data stored by the data node modules 116 in the worker nodes 110. For instance, the metadata information 120 may provide locality information of the data to the task tracker module 118.

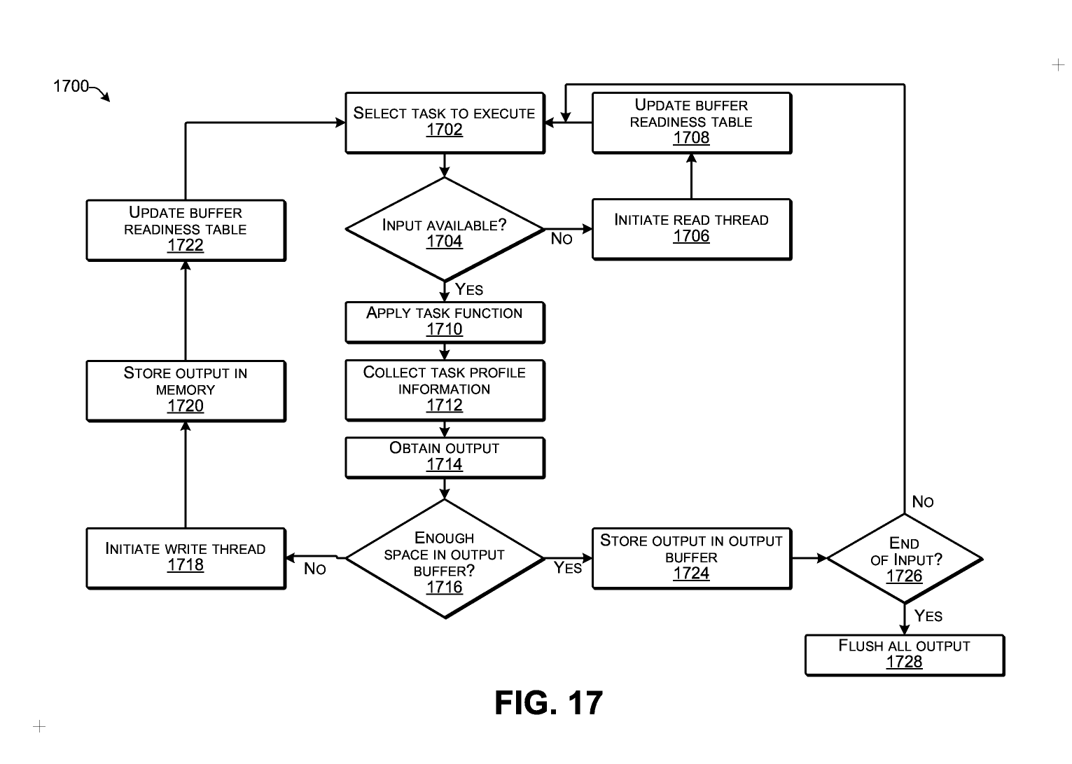

The job tracker 108 may receive one or more map-reduce jobs 122 submitted by one or more of the client devices 112 and may assign the corresponding map tasks 124 and/or reduce tasks 126 to be executed on respective processing slots 126 by respective task tracker modules 118 in the worker nodes 110. For instance, the task tracker module 118 may execute and monitor the map tasks 124 and/or reduce tasks 126 as assigned by the job tracker 108. The task tracker module 118 can report the status of the map tasks 124 and/or reduce tasks 126 of the respective worker node 110 to the job tracker 108. The map tasks 124 and/or reduce tasks 126 executed by the task tracker module 118 may read data from and/or write data to one or more of the data node modules 116, such as may be determined by the job tracker 108 and based on the metadata information 120 from the name node 106. Structural support for an algorithm executed by the task tracker module 118 is provided below, e.g., with respect to FIG. 17 and the corresponding discussion.

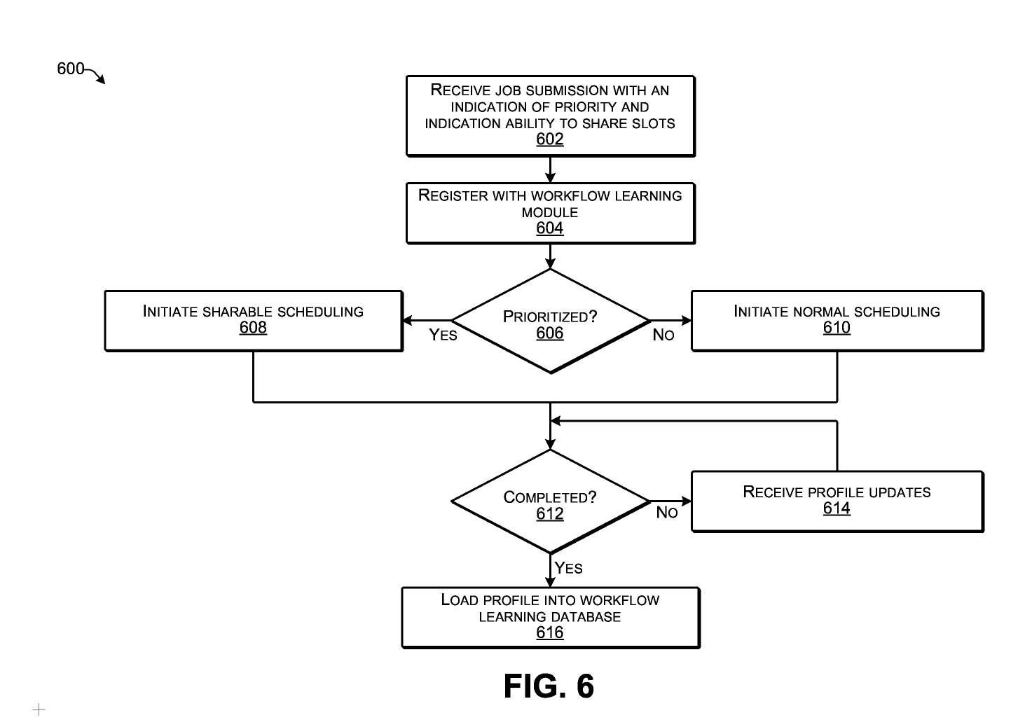

In some examples, the job tracker 108 includes one or more modules 130 to determine tasks 124, 126 able to share processing slots 128 in the worker nodes 110. As mentioned above, a processing slot 128 may be a portion of the computing resources (e.g., processing capacity and memory) of the worker node 110 that is reserved for processing a task 124 or 126. As several non-limiting examples, each worker node 110 may have 4 slots, 7 slots, 32 slots, etc., depending at least in part on the number of processing cores, the quantity of available memory, and so forth, in each physical computing device used as a worker node 110. According to implementations herein, one or more of the modules 130 may receive an incoming map-reduce job 122 and may determine, based at least in part on a priority associated with the job 122, whether one or more tasks 124, 126 associated with the job 122 are able to share a processing slot 128 with a task of another job that is already assigned and/or being executed in the processing slot 128. Structural support for the modules 130 that determine which tasks are able to share a slot and for performing other functions herein attributed to the job tracker 108 is included additionally below, e.g., with respect to FIGS. 6, 9, 13, and 22.

The administrator device 114 may be used by an administrator 132 to configure the cluster upon startup of the cluster as well as while the cluster is running. As discussed additionally below, the administrator 132 may use the administrator device 114 to view, analyze, and manage the workflow of the map-reduce cluster in the system 100.

In some examples, the one or more networks 104 may include a local area network (LAN). However, implementations herein are not limited to a LAN, and the one or more networks 104 can include any suitable network, including a wide area network, such as the Internet; an intranet; a wireless network, such as a cellular network, a local wireless network, such as Wi-Fi, and/or close-range wireless communications, such as BLUETOOTH®; a wired network; a direct wired connection, or any combination thereof. Components used for such communications can depend at least in part upon the type of network, the environment selected, or both. Protocols for communicating over such networks are well known and will not be discussed herein in detail. Accordingly, the computing devices 102 are able to communicate over the one or more networks 104 using wired or wireless connections, and combinations thereof. Further, while an example system architecture has been illustrated and discussed herein, numerous other system architectures will be apparent to those of skill in the art having the benefit of the disclosure herein.

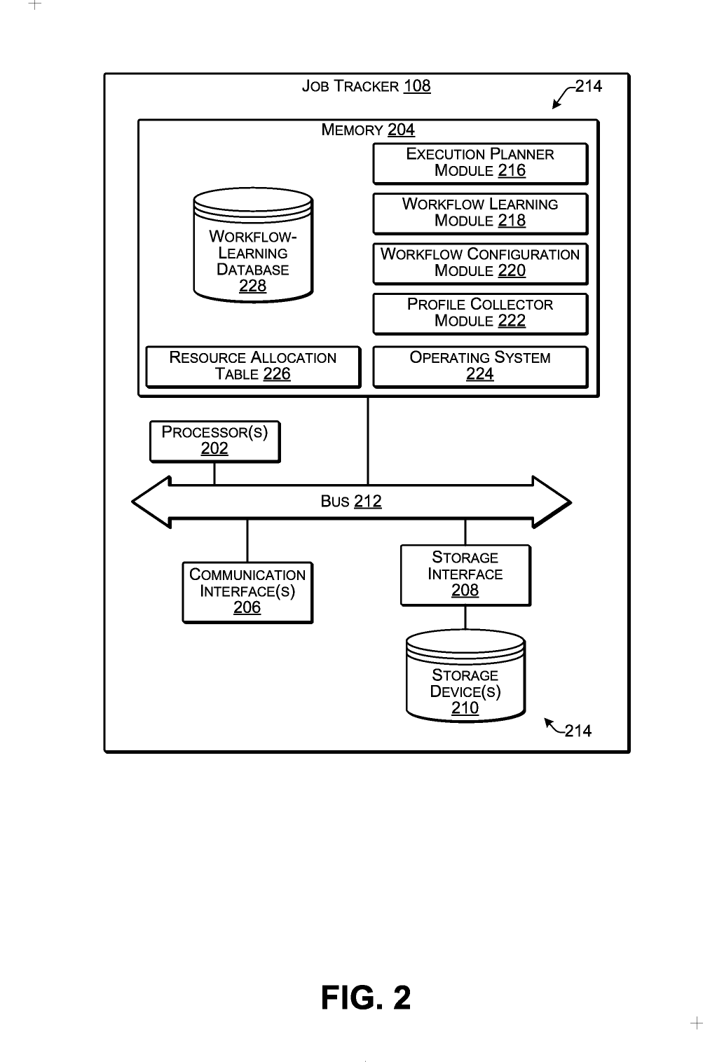

FIG. 2 illustrates select components of an example computing device configured as the job tracker 108 according to some implementations. In the illustrated example, the job tracker 108 may include one or more processors 202, a memory 204, one or more communication interfaces 206, a storage interface 208, one or more storage devices 210, and a system bus 212.

Each processor 202 may be a single processing unit or a number of processing units, and may include single or multiple computing units or multiple processing cores. The processor(s) 202 can be implemented as one or more central processing units, microprocessors, microcomputers, microcontrollers, digital signal processors, state machines, logic circuitries, and/or any devices that manipulate signals based on operational instructions. For instance, the processor(s) 202 may be one or more hardware processors and/or logic circuits of any suitable type specifically programmed or configured to execute the algorithms and processes described herein. The processor(s) 202 can be configured to fetch and execute computer-readable instructions stored in the memory 204, which can program the processor(s) 202 to perform the functions described herein. Data communicated among the processor(s) 202 and the other illustrated components may be transferred via the system bus 212 or other suitable connection.

In some cases, the storage device(s) 210 may be at the same physical location as the job tracker 108, while in other examples, the storage device(s) 210 may be remote from the job tracker 108, such as located on the one or more networks 104 described above. The storage interface 208 may provide raw data storage and read/write access to the storage device(s) 210.

The memory 204 and storage device(s) 210 are examples of computer-readable media 214. Such computer-readable media 214 may include volatile and nonvolatile memory and/or removable and non-removable media implemented in any type of technology for storage of information, such as computer-readable instructions, data structures, program modules, or other data. For example, the computer-readable media 214 may include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the pipeline manager 208, the computer-readable media 314 may be a type of computer-readable storage media and/or may be a tangible non-transitory media to the extent that when mentioned, non-transitory computer-readable media exclude media such as energy, carrier signals, electromagnetic waves, and/or signals per se.

The computer-readable media 214 may be used to store any number of functional components that are executed by the processor(s) 202. In many implementations, these functional components comprise instructions or programs that are executable by the processor(s) 202 and that, when executed, specifically configure the processor(s) 202 to perform the actions attributed herein to the job tracker 108. Functional components stored in the computer-readable media 214 may include an execution planner module 216, a workflow learning module 218, a workflow configuration module 220, and a profile collector module 222. For instance, the modules 216-222 may correspond to the modules 130 for determining tasks able to share slots discussed above with respect to FIG. 1. As one example, these modules may be stored in storage device(s) 210, loaded from the storage device(s) 210 into the memory 204, and executed by the one or more processors 202. Additional functional components stored in the computer-readable media 214 may include an operating system 224 for controlling and managing various functions of the job tracker 108.

In addition, the computer-readable media 214 may store data and data structures used for performing the functions and services described herein. The computer-readable media 214 may store a resource allocation table 226, which may be accessed and/or updated by one or more of the modules 216-222. The computer-readable media 214 may also store a workflow learning database 228, which may be accessed and/or updated by one or more of the modules 216-222. The workflow learning database 228 may access the storage interface 208 via the system bus 212 to read in data from or write out data into the one or more storage device(s) 210. The job tracker 108 may also include or maintain other functional components and data, which may include programs, drivers, etc., and the data used or generated by the functional components.

The communication interface(s) 206 may include one or more interfaces and hardware components for enabling communication with various other devices, such as over the network(s) 104 discussed above. For example, communication interface(s) 206 may enable communication through one or more of a LAN, the Internet, cable networks, cellular networks, wireless networks (e.g., Wi-Fi) and wired networks, direct connections, as well as close-range communications such as BLUETOOTH®, and the like, as additionally enumerated elsewhere herein.

Further, while FIG. 2 illustrates the components and data of the job tracker 108 as being present in a single location, these components and data may alternatively be distributed across different computing devices and different locations in any manner. Consequently, the functions may be implemented by one or more computing devices, with the various functionality described above distributed in various ways across the different computing devices. The described functionality may be provided by the computing devices of a single entity or enterprise, or may be provided by the computing devices and/or services of multiple different entities or enterprises.

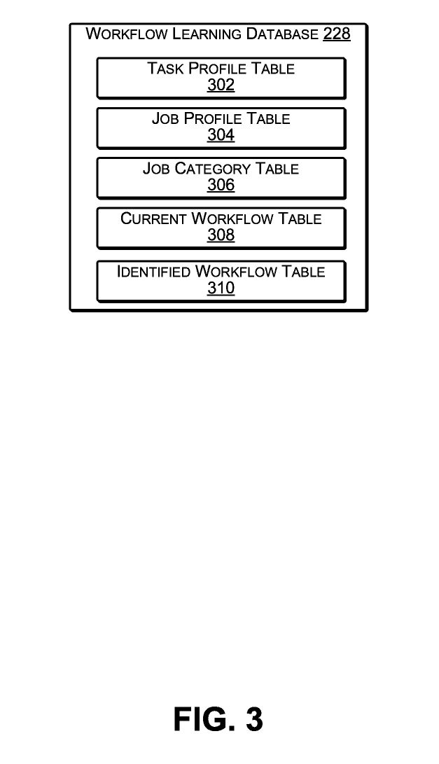

FIG. 3 illustrates an example of contents of the workflow learning database 228. As depicted in FIG. 3, the workflow learning database may include a plurality of tables, which may include a task profile table 302, a job profile table 304, a job category table 306, a current workflow table 308, and an identified workflow table 310. As discussed additionally below, the task profile table 302 provides a resource usage profile of individual tasks; the job profile table 304 provides a resource usage profile of individual jobs; the job category table 306 provides an indication of a classification of jobs; the current workflow table 308 provides details of a received job workflow; and the identified workflow table 310 provide details of jobs corresponding to particular workflows.

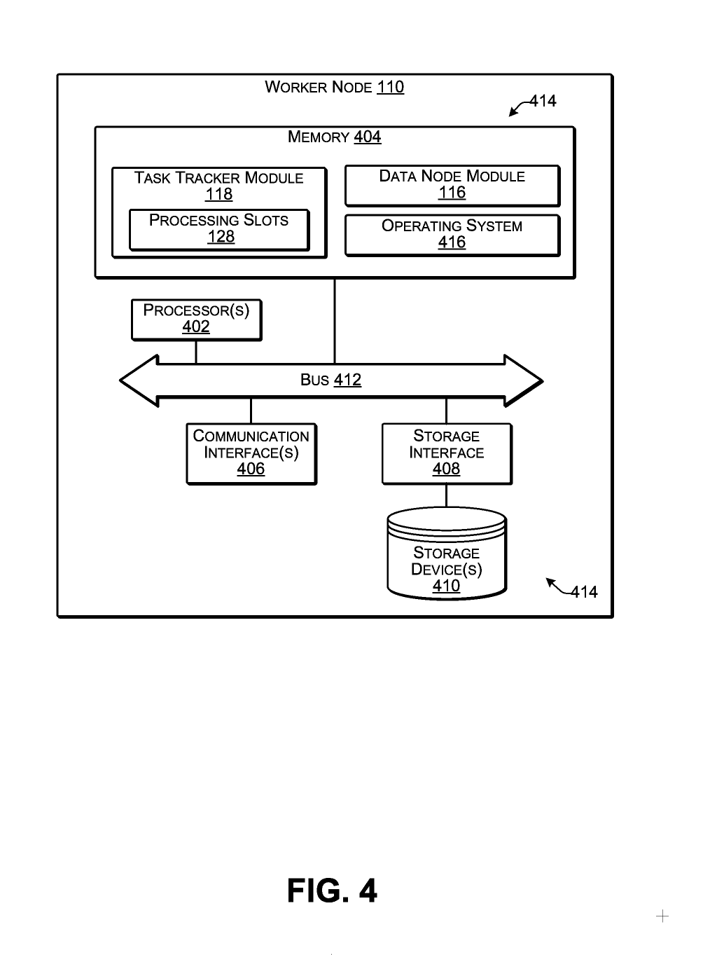

FIG. 4 illustrates select components of an example computing device configured as the worker node 110 according to some implementations. In some examples, the worker node 110 may include one or more servers or other types of computing devices that may be embodied in any number of ways. In the illustrated example, the worker node 110 may include one or more processors 402, a memory 404, one or more communication interfaces 406, a storage interface 408, one or more storage devices 410, and a system bus 412.

Each processor 402 may be a single processing unit or a number of processing units, and may include single or multiple computing units or multiple processing cores. The processor(s) 402 can be implemented as one or more central processing units, microprocessors, microcomputers, microcontrollers, digital signal processors, state machines, logic circuitries, and/or any devices that manipulate signals based on operational instructions. For instance, the processor(s) 402 may be one or more hardware processors and/or logic circuits of any suitable type specifically programmed or configured to execute the algorithms and processes described herein. The processor(s) 402 can be configured to fetch and execute computer-readable instructions stored in the memory 404, which can program the processor(s) 402 to perform the functions described herein. Data communicated among the processor(s) and the other illustrated components may be transferred via the system bus 412 or other suitable connection.

In some cases, the storage device(s) 410 may be at the same location as the worker node 110, while in other examples, the storage device(s) 410 may be remote from the worker node 110, such as located on the one or more networks 104 described above. The storage interface 408 may provide raw data storage and read/write access to the storage device(s) 410.

The memory 404 and storage device(s) 410 are examples of computer-readable media 414. Such computer-readable media 414 may include volatile and nonvolatile memory and/or removable and non-removable media implemented in any type of technology for storage of information, such as computer-readable instructions, data structures, program modules, or other data. For example, the computer-readable media 414 may include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the data node 210, the computer-readable media 414 may be a type of computer-readable storage media and/or may be a tangible non-transitory media to the extent that when mentioned, non-transitory computer-readable media exclude media such as energy, carrier signals, electromagnetic waves, and/or signals per se.

The computer-readable media 414 may be used to store any number of functional components that are executable by the processor(s) 402. In many implementations, these functional components comprise instructions or programs that are executable by the processor(s) 402 and that, when executed, specifically configure the processor(s) 402 to perform the actions attributed herein to the worker node 110. Functional components stored in the memory 404 may include the data node module 116 and the task tracker module 118. The task tracker module 118 may be configured to provide a plurality of processing slots 128. As one example, these modules may be stored in the storage device(s) 410, loaded from the storage device(s) 410 into the memory 404, and executed by the one or more processors 402. Additional functional components stored in the memory 404 may include an operating system 416 for controlling and managing various functions for the worker node 110.

In addition, the computer-readable media 404 may store data and data structures used for performing the functions and services described herein. The worker node 110 may also include or maintain other functional components and data, which may include programs, drivers, etc., and the data used or generated by the functional components. Further, the worker node 110 may include many other logical, programmatic, and physical components, of which those described above are merely examples that are related to the discussion herein.

The communication interface(s) 406 may include one or more interfaces and hardware components for enabling communication with various other devices, such as over the network(s) 104. For example, communication interface(s) 406 may enable communication through one or more of a LAN, the Internet, cable networks, cellular networks, wireless networks (e.g., Wi-Fi) and wired networks, direct connections, as well as close-range communications such as BLUETOOTH®, and the like, as additionally enumerated elsewhere herein.

Additionally, the other computing devices 102 described above may have hardware configurations similar to those discussed above with respect to the job tracker 108 and the worker node 110, but with different data and functional components to enable them to perform the various functions discussed herein.

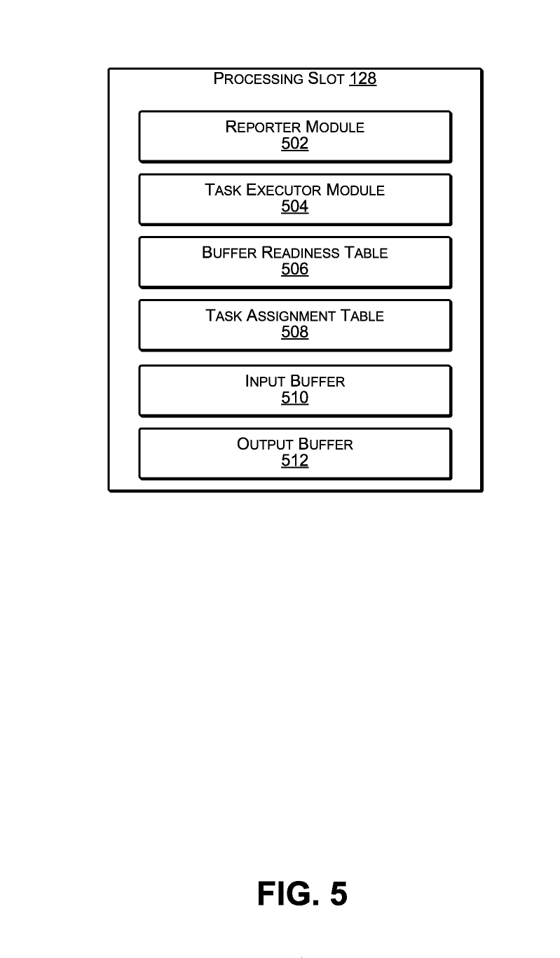

FIG. 5 illustrates an example of modules and information associated with providing a processing slot 128 according to some implementations. As depicted in FIG. 5, each processing slot 128 may be associated with a reporter module 502 and a task executor module 504. The processing slot 128 may further be associated with a buffer readiness table 506 and a task assignment table 508. These tables 506 and/or 508 may be accessed and/or updated by one or more of the modules 502, 504 for managing tasks executed via a corresponding processing slot 128. In some examples, a separate report module 502 and/or task executor module 504 may be implemented for each processing slot 128 configured on a worker node, while in other examples, a single reporter module 502 and/or task executor module 504 may be used for multiple processing slots 128. The reporter module 502 and the task executor module 504 may be part of the task tracker module 118, and are structurally supported, e.g., by the algorithm described in association with FIG. 17 below, as well as in the prose herein.

In some implementations of map-reduce (e.g., Apache HADOOP® MapReduce version 1), the map-reduce framework may distinguish the processing slots 128 into mapper slots and reducer slots such that the mapper slots are designated for executing map tasks and the reducer slots are designated for executing reduce tasks. Other implementations of map-reduce (e.g., Apache HADOOP® MapReduce version 2—YARN) may be configured to execute map tasks and reduce tasks in the same slot 128 (alternatively referred to as a “container”). However, restrictions on the type of tasks executable on particular processing slots 128 does not affect the discussion of the examples herein. Accordingly, for ease of explanation, the processing slots 128 in the examples herein are not distinguished between mapper slots and reducer slots unless specifically mentioned.

In addition, an input buffer 510 and an output buffer 512 may be associated with each processing slot 128. For example, each buffer 510, 512, may be a portion of memory 404 designated for storing data associated with tasks executed by the resources associated with the processing slot 128. The buffer readiness table 506 may indicate the status of the buffers 510, 512.

FIGS. 6, 9, 13, 15, 17, and 22 are flow diagrams illustrating example processes according to some implementations. The processes are illustrated as collections of blocks in logical flow diagrams, which represent a sequence of operations, some or all of which can be implemented in hardware, software or a combination thereof. In the context of software, the blocks may represent computer-executable instructions stored on one or more computer-readable media that, when executed by one or more processors, program the processors to perform the recited operations, algorithms, or the like. Generally, computer-executable instructions include routines, programs, objects, components, data structures and the like that perform particular functions, algorithmic operations, or implement particular data types. The order in which the blocks are described should not be construed as a limitation. Any number of the described blocks can be combined in any order and/or in parallel to implement the process, or alternative processes, and not all of the blocks need be executed. For discussion purposes, the processes are described with reference to the environments, frameworks and systems described in the examples herein, although the processes may be implemented in a wide variety of other environments, frameworks and systems.

FIG. 6 is a flow diagram illustrating an example process 600 for scheduling a job based at least in part on priority according to some implementations. For instance, the process 600 may include an algorithm executed by the job tracker 108 when the job tracker 108 receives a job submission from a client 150.

At 602, the job tracker 108 receives, e.g., from a client device, a job submission along with an indication of a priority associated with the job, and an indication that tasks associated with the job may share slots with other tasks. For example, the job submission may include a job definition, which may include the indication of priority and the indication as to whether the tasks of this job may share a slot with another task. The job definition may further include an indication of a number of map tasks and reduce tasks associated with the newly submitted job. This newly submitted job may be referred to hereinafter as the received job.

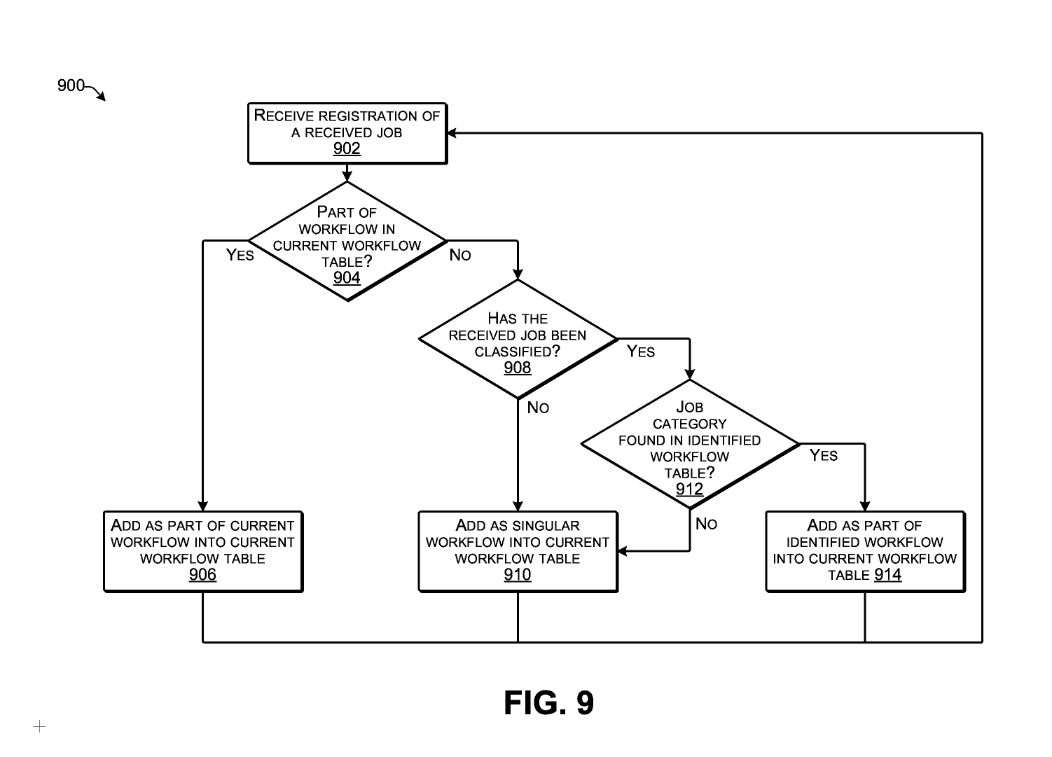

At 604, the job tracker 108 may register the received job with the workflow learning module 218, as described additionally below with respect to the discussion of FIG. 9.

At 606, after the registration of the received job with the workflow learning module 218, the job tracker 108 may determine whether the received job is a prioritized job, i.e., whether the received job has a higher priority than one or more other jobs that have been previously received.

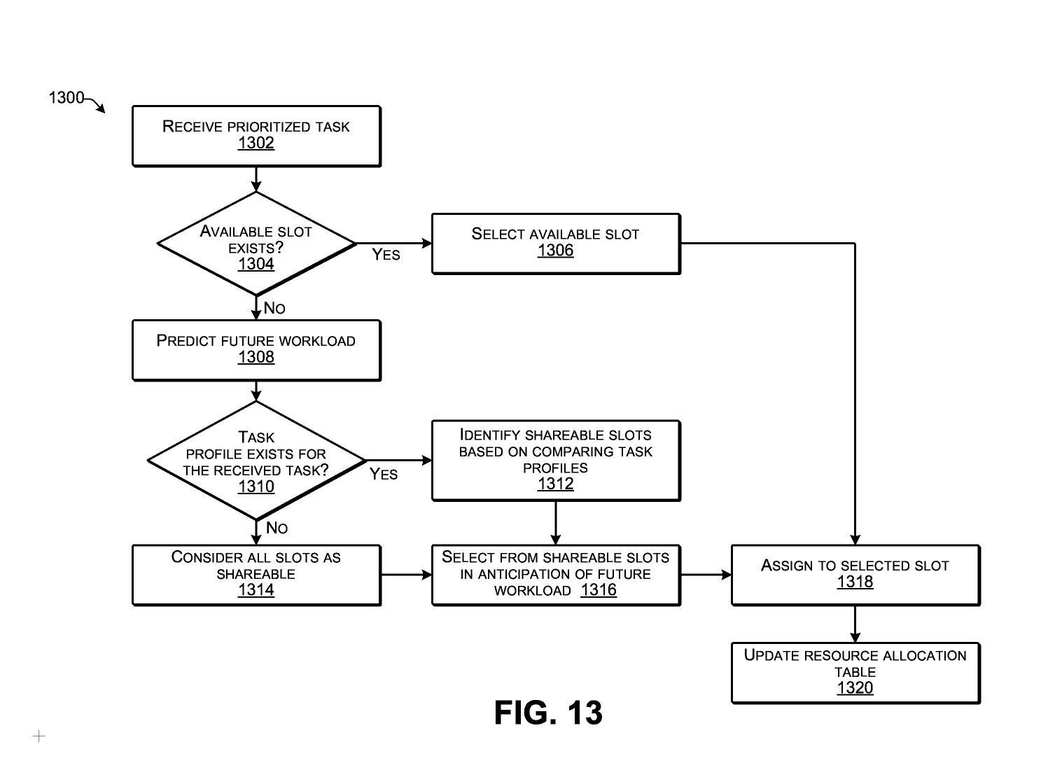

At 608, if the received job is a prioritized job, the job tracker 108 may initialize initiate shareable scheduling. For example, to prioritize execution of the received job, the job tracker 108 may attempt to assign execution of the tasks associated with the received job on shared slots on the worker nodes. Processes and algorithms associated with block 608 are discussed additionally below with respect to FIG. 13.

At 610, on the other hand, if the received job is not indicated to be a prioritized job, then the job tracker 108 may proceed with normal scheduling of the received job. For example, normal scheduling of the received job may include any conventional map-reduce job scheduling techniques to assign one or more worker nodes to execute the tasks associated with the received job.

At 612, the job tracker 108 waits for the job to be completed by the scheduled worker nodes.

At 614, while waiting for the received job to be completed, the job tracker 108 may receive profile updates received by the profile collector module 222 of the job tracker 108. For example, the profile updates may be sent to the profile collector module 222 by the reporter modules 502 associated with each of the processing slots 128 of all the worker nodes 110 assigned to execute the tasks associated with the received job. Upon receiving each profile update, the job tracker may update the task profile table 302 and the job profile table 304 in the workflow learning database 228.

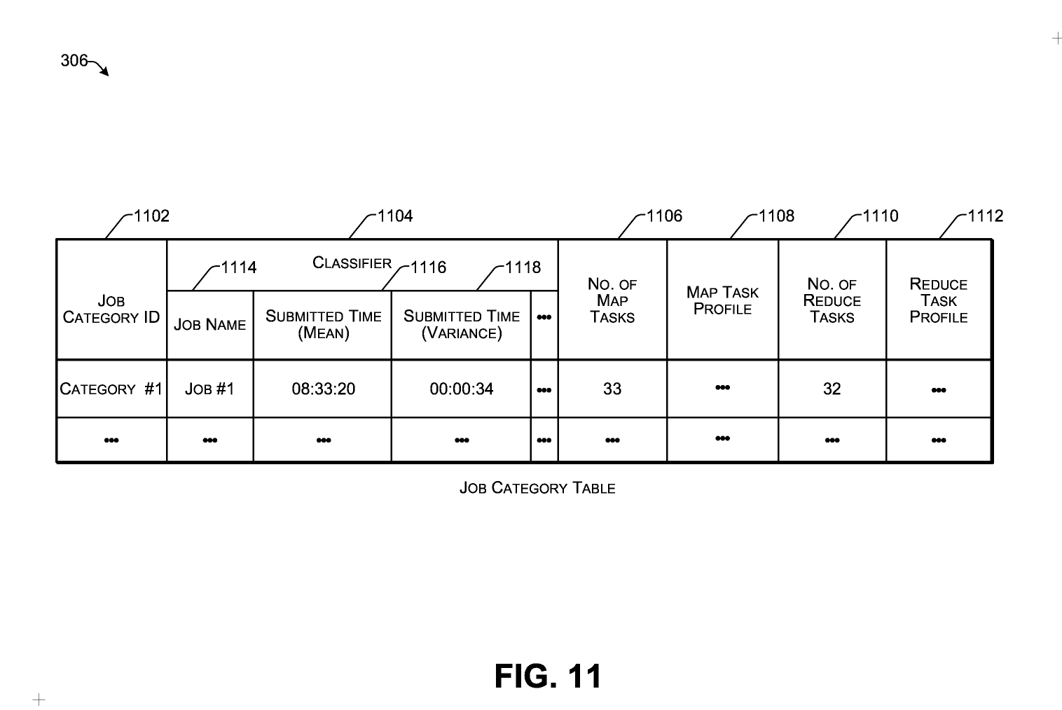

At 616, following completion of the received job, the job tracker 108 may store the profile information in the workflow learning database. For instance, the job tracker 108 may store the updated task profile information and the updated job profile information in the workflow learning database 228 by updating the task profile table 302 and the job profile table 304. The job tracker may also update the job category table 306 as discussed additionally below with respect to FIG. 11.

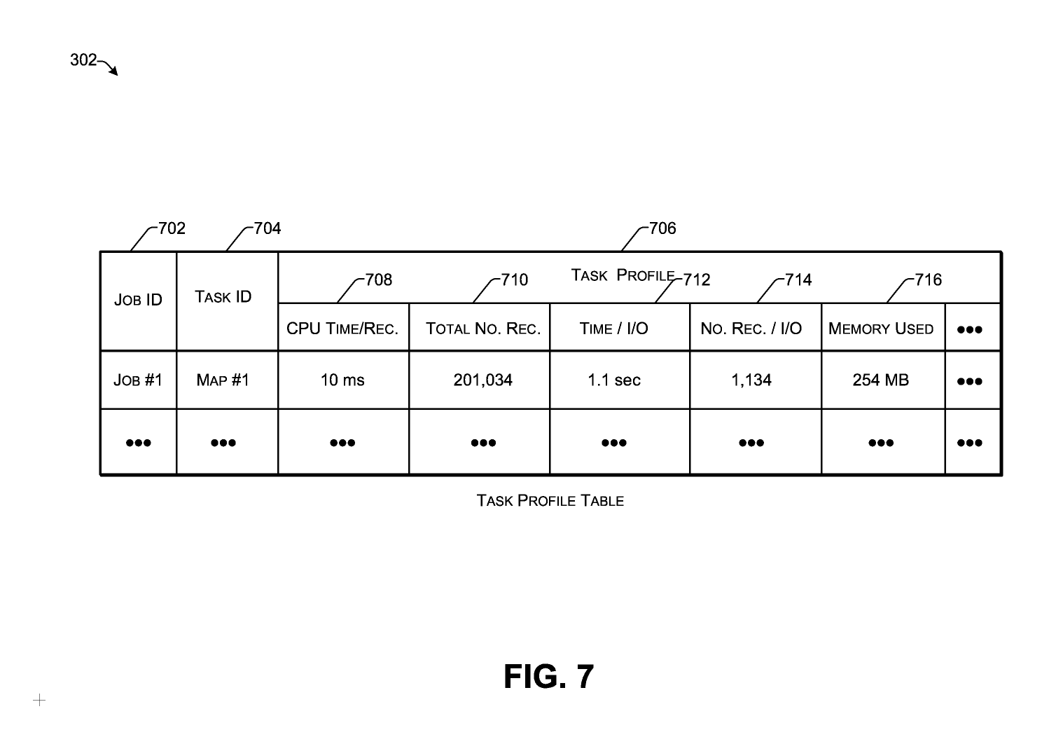

FIG. 7 illustrates an example of a structure of a task profile table 302 according to some implementations. In the illustrated example, the task profile table 302 includes, for individual jobs, a job ID 702, a task ID 704, and a task profile 706. The job ID values for the job IDs 702 may be cluster-unique IDs or otherwise individually distinguishable IDs assigned by the job tracker 108 upon job submission for identifying particular jobs. Similarly, the task ID values for task IDs 704 may be cluster-unique IDs or otherwise individually distinguishable IDs assigned by the job tracker 108 for identifying individual tasks of a job. The parameters of the task profile 706 may be dependent at least in part on the implementation.

In some examples, the task profile 706 for each task may include, but is not limited to, a CPU time per record 708, a total number of records 710, a time per I/O 712, a number of records per I/O 714, and an amount of memory used 716. The CPU time per record 708 may indicate the average amount of time for processing each key/value pair for the particular task. The total number of records 710 may indicate the total number of key/value pairs for the particular task. The time per I/O 712 may indicate the average time taken to perform each I/O operation for the particular task. The number of records per I/O 714 may indicate the average number of records processed before an I/O is performed for the particular task. The memory used 716 may indicate the total amount of memory used for the particular task. These values may be provided by the respective reporter module 502 of the respective worker node that executes the particular task, as discussed, e.g., with respect to block 616 of FIG. 6. Thus, the task profile table 302 provides values for a number of parameters of a task profile 706 associated with each task executed for a particular job. The parameters 708-716 may be used to determine one or more estimated processor processing durations and one or more input/output (I/O) durations for the particular task. Furthermore, while several example parameters 708-716 of a task profile 706 are described in the example of FIG. 7, other examples of the task profile 706 may include additional or alternative parameters.

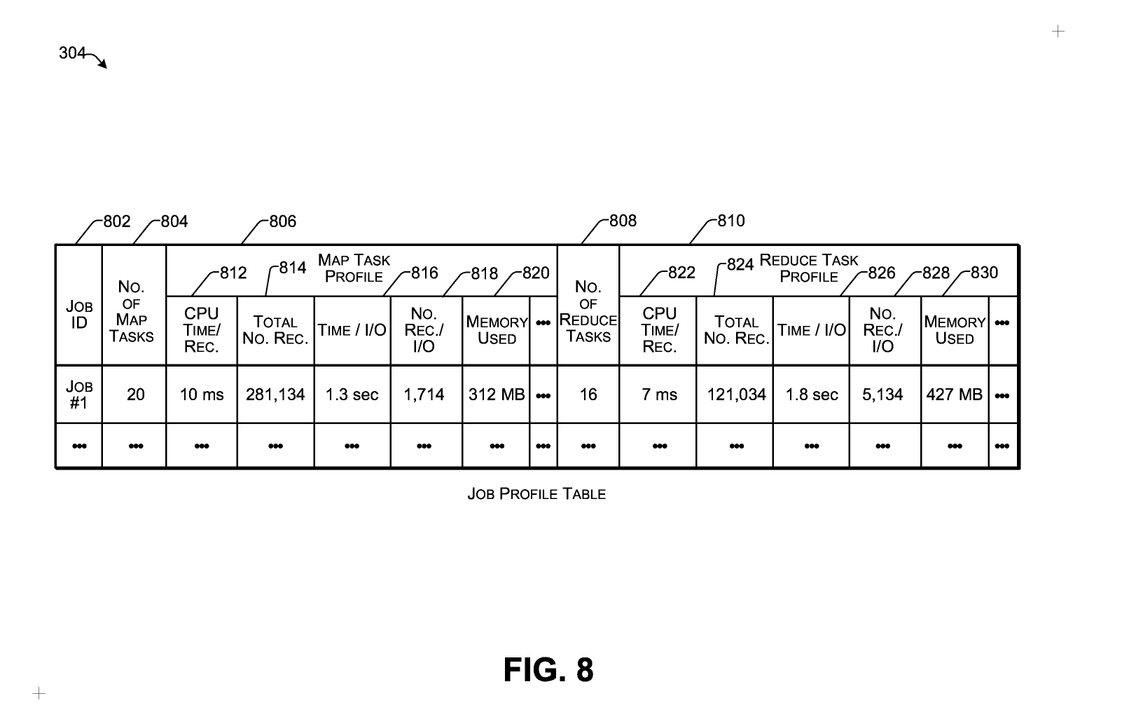

FIG. 8 illustrates an example of a structure of a job profile table 304 according to some implementations. In the illustrated example, for each job, the job profile table 304 includes a job ID 802, a number of map tasks 804, a map task profile 806, a number of reduce tasks 808, and a reduce task profile 810. The value for job ID at 802 is a cluster-unique ID or otherwise individually distinguishable ID assigned by the job tracker 108 upon job submission to identify the job. The values for the number of map tasks 804 and the number-of-reduce-tasks 808 are respectively the total number of map tasks and reduce tasks for this job as counted in the task profile table 302.

The map task profile 804 and the reduce task profile 806 both include similar parameters as the task profile 706 of the task profile table 302 discussed above with respect to FIG. 7. In this example, the map task profile parameters include a CPU time per record 812, a total number of records 814, a time per I/O 816, a number of records per I/O 818, and an amount of memory used 820. Similarly, the reduce task profile parameters include a CPU time per record 822, a total number of records 824, a time per I/O 826, a number of records per I/O 828, and an amount of memory used 830.

For a particular job, the parameters 812-820 of the map task profile values 806 are the aggregated averages of the respective parameters 708-716 of the task profiles 706 of all the map tasks in the task profile table 302 for the particular job, i.e., an aggregation and average of each parameter 708-716 of all 20 map tasks for Job #1 in this example. Similarly, the values of the parameters 822-830 for the reduce task profile 810 are the aggregated averages of the respective parameters 708-716 of the task profiles 706 of all the reduce tasks in the task profile table 302 for the particular job, i.e., an aggregation and average of each parameter 708-716 of all 16 reduce tasks for Job #1 in this example. As one example, at 812, the CPU time/record is 10 ms, which means that the 20 map tasks of Job #1 took an average CPU time/record of 10 ms. The job profile table 304 may be updated whenever the task profile table 302 is updated. In some examples, this means that the averages in the job profile table 304 may be recalculated when the task profile table 302 is updated.

FIG. 9 is a flow diagram that illustrates an example process for registration of a received job executed according to the workflow learning module 218, such as discussed above with respect to block 604 of FIG. 6. In some examples, the process 900 includes an algorithm structure of the workflow learning module 218 executed by the job tracker 108.

At 902, the workflow learning module 218 receives registration of a received job. As mentioned above, the workflow learning module 218 may be included in the job tracker 108 as one of the modules 130 for determining tasks able to share slots.

At 904, the workflow learning module 218 determines if the received job is part of a currently executing workflow. For instance, the workflow learning module 218 may refer to the current workflow table 308 to determine whether the received job is part of a currently executing workflow. A workflow may comprise a plurality of map-reduce jobs that are related to each other. In some examples, a workflow may be an ordered sequence of job executions in which each job, other than the first job, uses the output of one or more of the previous jobs as its input. For example, several map reduce jobs may be part of the same workflow such as in the case in which one or more map-reduce jobs use data output from a previously executed map-reduce job. Accordingly, the workflows herein may include multiple map reduce jobs that are related, such as map-reduce jobs that are executed sequentially, receive data from a previous job, or that otherwise share data.

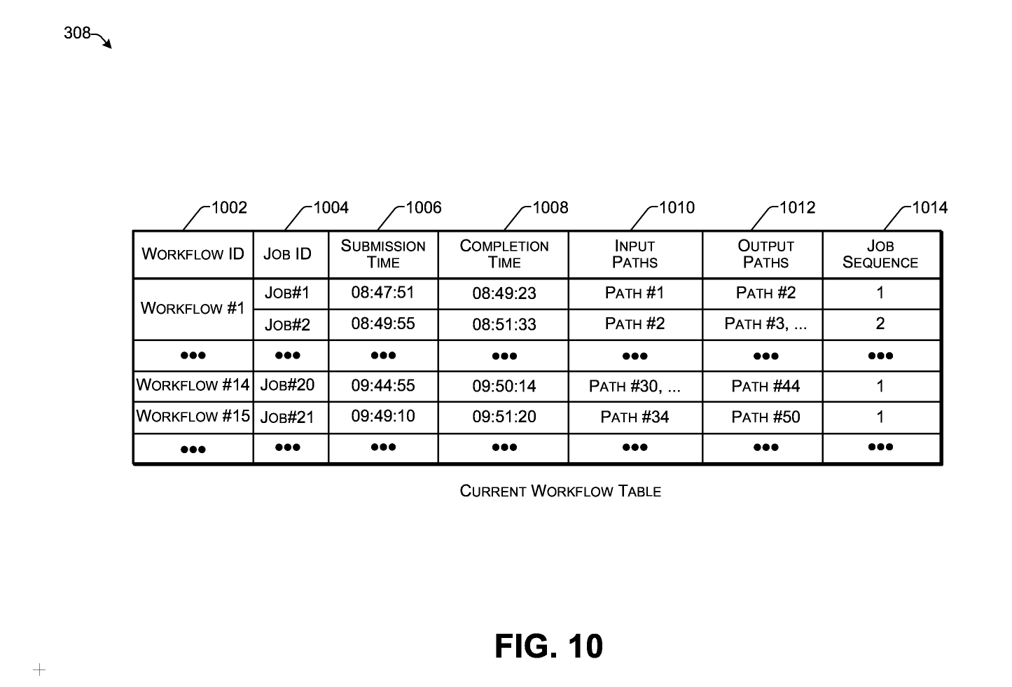

FIG. 10 illustrates an example of the structure of a current workflow table 308 according to some implementations. In the example of FIG. 10, the current workflow table 308 includes, for each identified workflow, a workflow ID 1002, a job ID 1004, a submission time 1006, a completion-time 1008, input paths 1010, output-paths 1012, and a job-sequence 1014. The value for the workflow ID 1002 may be a cluster-unique ID, or other individually distinguishable ID, generated by the job tracker 108 for referencing each identified workflow. The value for the job ID 1004 may also be a cluster-unique ID, or other individually distinguishable ID, assigned by the job tracker 108 upon job submission to identify the job. The job ID's may identify each job determined to be associated with a particular workflow ID.

The value for submission-time 1006 is the time of submission for the corresponding job ID 1004. The value for completion-time 1008 is the time of completion for the corresponding job. The value(s) for input-path(s) 1010 are cluster-unique names, or other individually distinguishable IDs, for locating the input data for the corresponding job. In some implementations, the values for input-paths 1010 are the path names of the input files or directories for the particular job. The value(s) for output-path(s) 1012 are the cluster-unique names, or other individually distinguishable IDs, for locating the output data for the corresponding job. In some implementations, the values for output paths 1012 are the path names of the output files for the corresponding job.

The value for job-sequence 1014 is the order of the job in the particular workflow 1002. A job can be deemed as part of a workflow if the job uses the output data of one or more of the jobs of the same workflow. This can be determined for a particular job by checking whether the set of input path values for the particular job is a subset of the set of all the output path values 1010 of a particular workflow-ID 1002 and the value of the job's submission-time 1006 comes after all the values of the completion times 1008 of the jobs 1004 whose output data is being used.

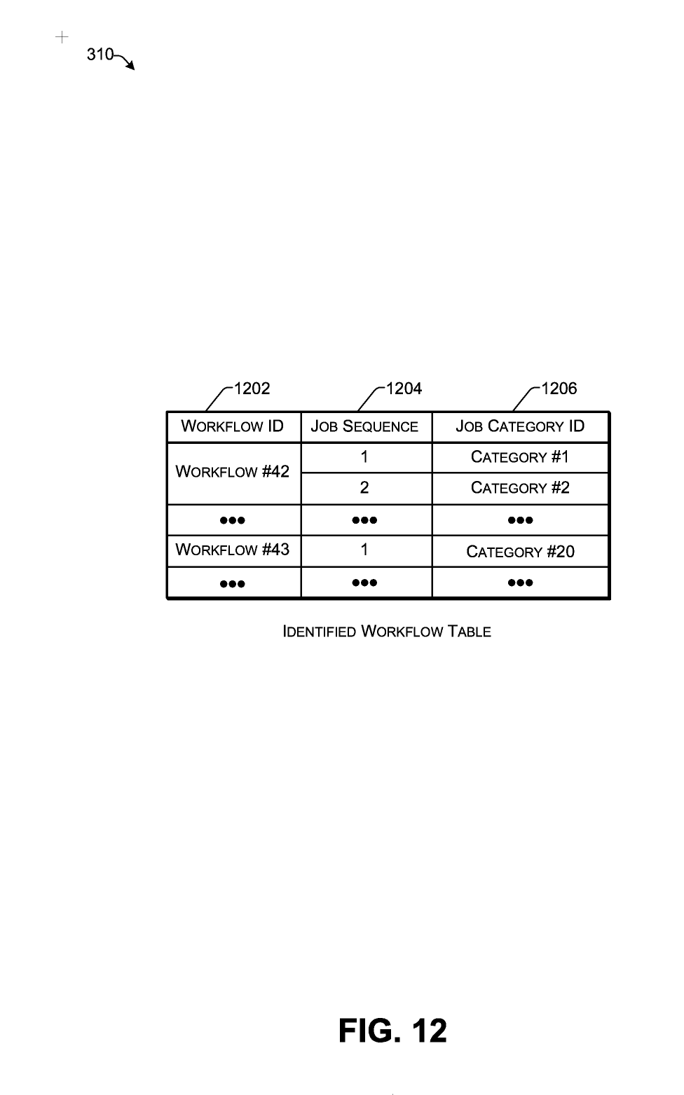

Referring back to FIG. 9, at 906, if the received job is determined to be part of a particular workflow in the current workflow table 308, the received job may be added to the particular workflow as the most recent entry (i.e., next in the sequence). In some implementations, a classification algorithm allows for incremental update to the identified job categories in the job category table 306. In this case, upon job completion at 616 of FIG. 6, the entries in the current workflow table 308 may be used to update the job category table 306 and the identified workflow table 310. The updating of the job category table 306 and the identified workflow table 310 are described additionally below in the discussion with respect to FIGS. 11 and 12, respectively.

At 908, if the received job is not associated with any workflows in the current workflow table 308 when checked at block 904, the workflow learning module 218 may determine whether the received job has been classified in a particular job category. For instance, submitted jobs may be classified into the same job category if the jobs are determined to be similar according to a set of predefined properties (e.g., job name, submission time, input path, and so forth.). For jobs that are classified in the same job category, implementations herein may adopt a heuristic such that jobs having similar properties are assumed to have a similar job profile.

FIG. 11 illustrates an example of a structure of the job category table 306 according to some implementations. As mentioned above with respect to FIG. 6, when the job tracker 108 detects the completion of the received job at 612, the job tracker 108 may proceed to update the job category table 306 at 616. In the illustrated example, the job category table 306 includes, for each job category, a job category ID 1102, a classifier 1104, a number of map tasks 1106, a map task profile 1108, a number of reduce tasks 1110, and a reduce task profile 1112. The value for the job category ID 1102 may be a cluster-unique ID, or other individually distinguishable ID, generated by the job tracker 108 for each identified category of jobs. The classifier 1104 may be used to determine if a particular job belongs to a particular job category. The type and configuration of the classifier 1104 is dependent, at least in part, on the type of classification algorithm used for a particular implementation, as well as the properties set by the administrator 132 via the administrator device 114.

In some examples, the classifier 1104 may include a job name 1114 of each job classified in the category, a submitted time mean 1116, and a submitted time variance 1118. As one example, naive Bayes classification may used to predict if a particular job belongs to a particular job category based on the job name and submitted time of the particular job. The number of map tasks 1106 and the number of reduce tasks 1110 may be, respectively, the average number of map tasks and average number of reduce tasks of the jobs in a particular job category. The map task profile 1108 and the reduce task profile 1112 are respectively the aggregated profiles of all the map tasks or reduce tasks, respectively, of the jobs in a particular job category 1102. In some implementations, these values are the averages of each respective measured parameter 812-820 and 822-830 as received in the job profile table 304 during blocks 612-616 of FIG. 6, as discussed above.

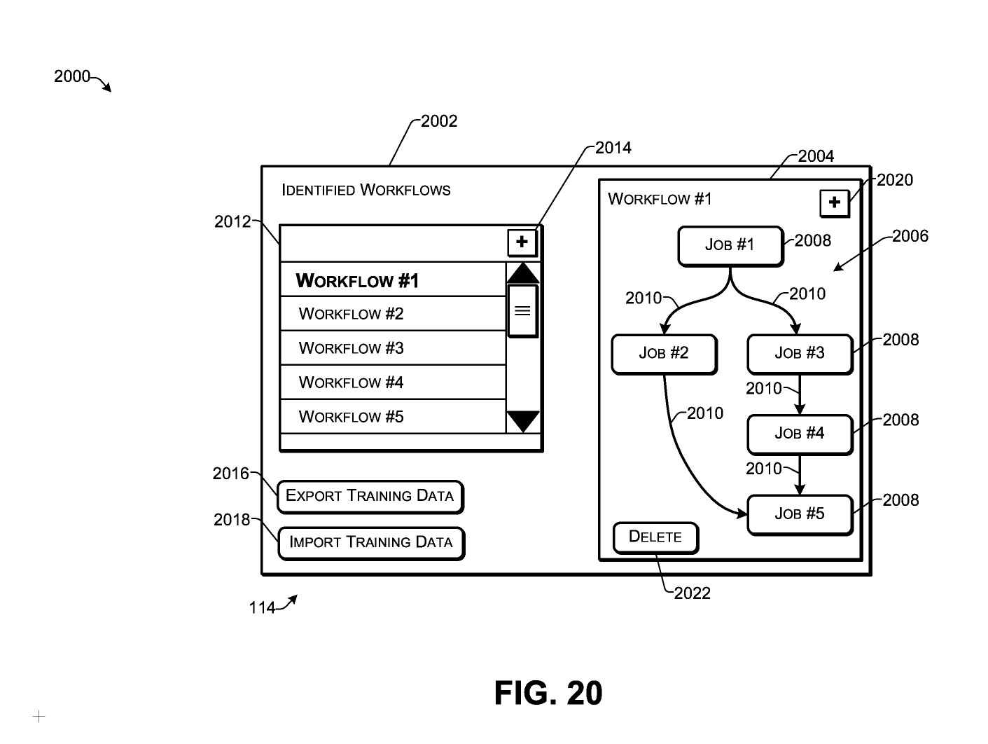

The entries in the job category table 306 may first be entered using a training set of jobs under the supervision of the administrator 132 using the administrator device 114. This technique is described additionally below in the discussion with respect to FIG. 20. In some examples, subsequent updates may be made to a particular job category 1102 when the jobs classified in that job category have been completed at block 616 of FIG. 6. For example if naive Bayes classification is used, the submitted time mean 1116 and the submitted time variance 1118 may be reevaluated based, at least in part, on the additions of new jobs into the job category. The values of the map task profile 1108 and the reduce task profile 1112 may also be reevaluated with the profiles of the newly added jobs. In some cases, such as when average values are used to aggregate the profile values, then these averages may be reevaluated using the newly added profile values.

Referring back to FIG. 9, at 910, if the received job has not been classified as belonging to a particular job category in the job category table 306 based on the classifier 1104, then the workflow learning module 218 may add the received job into the current workflow table as a singular workflow (i.e., a workflow with only one job).

At 912, on the other hand, if the received job is determined, based on the classifier, to belong to a particular job category, then the workflow learning module 218 may proceed to determine whether the corresponding job category belongs to a workflow in the identified workflow table 310.

FIG. 12 illustrates an example of a structure of the identified workflow table 310 according to some implementations. In the illustrated example, the identified workflow table 310 includes, for each workflow, a workflow ID 1202, a job may be a cluster-unique ID, or other individually distinguishable ID, generated by the job tracker 108 for reference to each identified workflow. The value for the job sequence 1204 may be the order of the job in the particular workflow. The value for the job category ID 1206 may be a cluster-unique ID, or other individually distinguishable ID, generated by the job tracker 108 for each identified job category of one or more jobs. The entries in the identified workflow table 310 are first entered using a training set of jobs under the supervision of an administrator via the administrator device 114. This is described additionally below with respect to the discussion of FIG. 20. In some implementations, the job tracker 108 may move the non-singular workflows (i.e., workflows with more than one job) in the current workflow table 308 into the identified workflow table 310. One reason for such a move is to perform incremental unsupervised training if the implementation permits.

Referring back to block 912 of FIG. 9, if the received job is not identified with any workflow in the identified workflow table 310, then at 910, the workflow learning module 218 may add the received job into the current workflow table as a singular workflow.

At 914, on the other hand, if the received job can be correlated to a particular workflow based on the job category, then the workflow learning module 218 may add the received job as part of the identified workflow by using the corresponding workflow ID 1202 in the identified workflow table 310 for the workflow ID entry 1002 in the current workflow table 308.

FIG. 13 is a flow diagram that illustrates an example process 1300 for sharable scheduling of tasks according to some implementations. For example, as discussed above with respect to block 608 of FIG. 6, the execution planner module 216 of the job tracker 108 may execute the process and algorithmic structure of FIG. 13 to assign multiple tasks for execution on the same processing slot of a worker node.

At 1302, the execution planner module 216, as part of the modules 130 of the job tracker 108, may receive a prioritized task, which may also be referred to herein as the received task. In some map-reduce operations, the scheduling of tasks may not be immediate upon job submission. For example, in some implementations, the map tasks might all be scheduled before the reduce tasks are scheduled. These particularities do not affect the implementations herein, as the execution planner module 216 may initiate the sharable scheduling process based on instructions from the job tracker 108.

At 1302, the execution planner module 216 may check in the resource allocation table 226 to determine whether there are any unoccupied processing slots on the worker nodes 110.

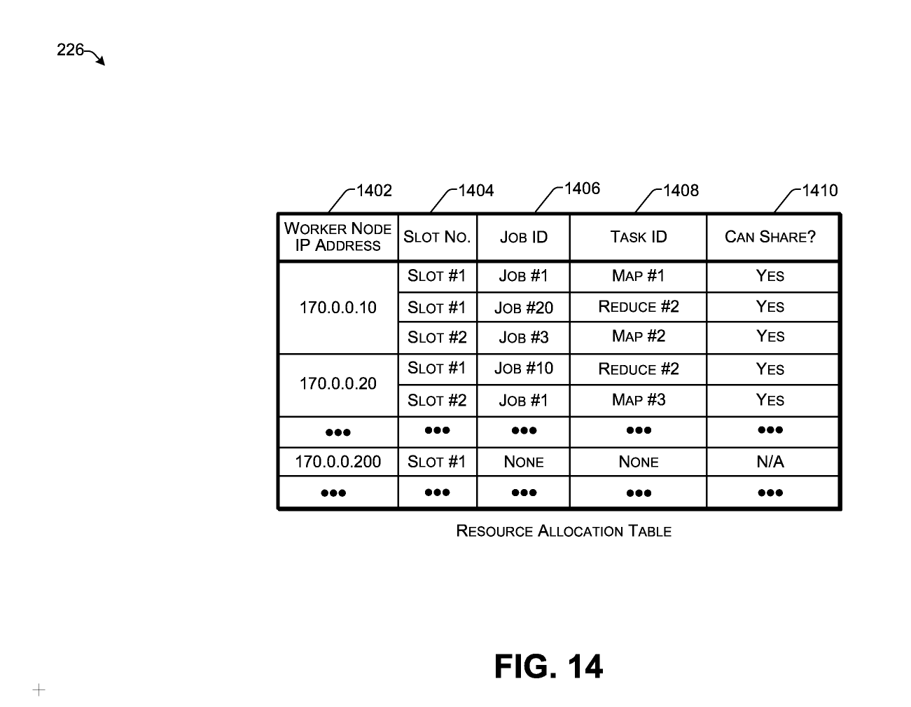

FIG. 14 illustrates an example of the structure of a resource allocation table 226 according to some implementations. In the illustrated example, the resource allocation table 226 includes, for each worker node, a worker node IP address 1402, a slot number 1404, a job ID 1406, a task ID 1408, and a can share indicator 1410. The value for the worker node IP address 1402 is the IP address of the worker node 110 to which the information of the table row corresponds. The slot number 1404 is the slot ID with which the worker node 110 identifies the processing slots 128 configured by its task tracker module 118. The value for the job ID 1406 is the cluster-unique ID, or other individually distinguishable ID, assigned to a particular job by the job tracker 108 upon job submission for identifying the job. The value for the task ID 1408 is the cluster-unique ID, or other individually distinguishable ID, assigned by the job tracker 108 upon job submission to identify the particular task of the particular job. The value for the can share indicator 1410 indicates whether the particular task can share a processing slot 1404 with another task. In some cases, the can-share value 1410 may be provided by the client device 112 upon job submission. Further, in some cases, the default value may be “yes” unless the client specifically indicates otherwise.

Referring back to FIG. 13, at 1306, if the execution planner module 216 detects available (i.e., currently unassigned) processing slots in the resource allocation table 226, the execution planner module 216 may proceed to select the available processing slot for the received task. The received task is assigned to the selected processing slot, as discussed at 1318, below, and the execution planner module 216 may add the entry of the received task into the resource allocation table 226, as discussed at 1320, below.

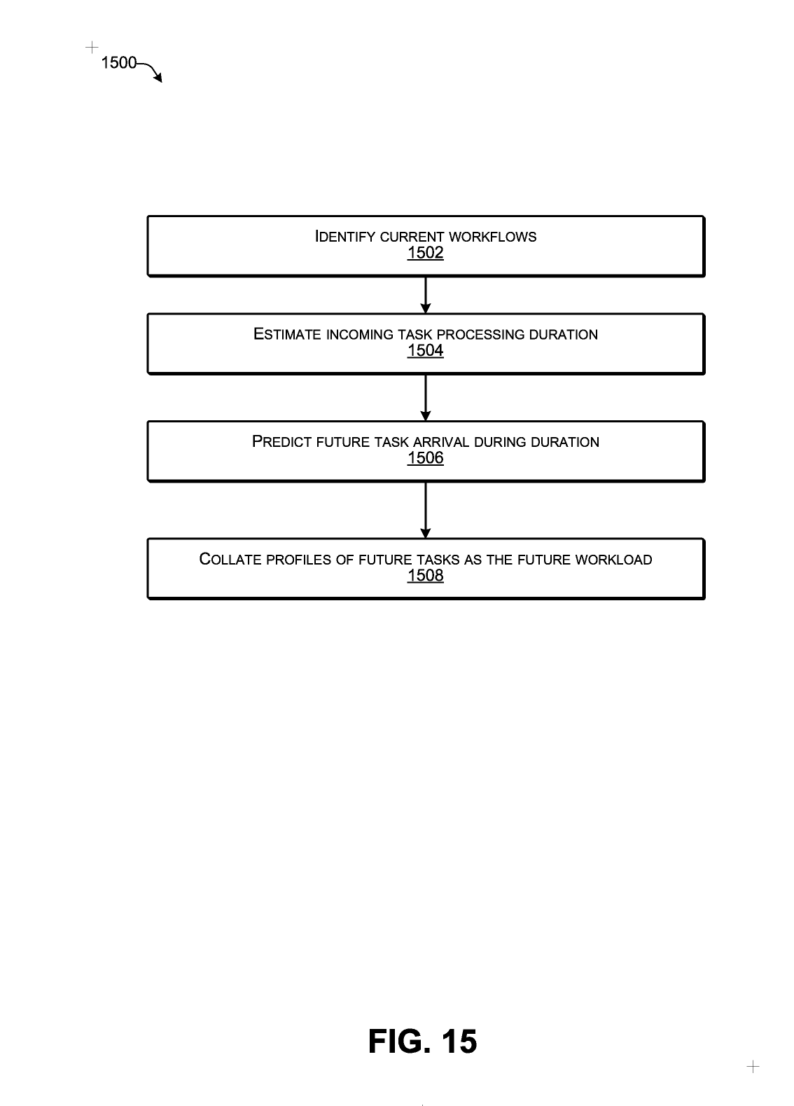

At 1308, on the other hand, if there are no available processing slots, the execution planner module 216 proceeds to predict the future workload as described with respect to the process and algorithm of FIG. 15.

FIG. 15 is a flow diagram illustrating an example process 1500 for the prediction of future workload in 1308 of FIG. 13 according to some implementations. The process 1500 indicates a structure of an algorithm of the execution planner module 216 of the job tracker 108 that may be executed for predicting a future workload.

At 1502, the execution planner module 216 may identify current workflows by retrieving all the currently executing workflows from the current workflow table 308.

At 1504, the execution planner module 216 may estimate the task processing duration of the received task. In some implementations, prior profile information from the task profile table 302 can be used as a reference if an entry for the received task exists in the task profile table 302. If a corresponding entry in the task profile table 302 cannot be found, a default value may be used instead.

At 1506, based on the estimated task processing duration of the received task and all the currently executing workflows, the execution planner module 216 may predict a set of all possible future tasks predicted to arrive during the processing of the received task. In some implementations, the prediction of future tasks may include determining the next jobs that are expected to arrive during the estimated task processing duration according to the currently executing workflows.

At 1508, based on the identified future tasks, the execution planner module 216 may collate the profiles of these tasks as the predicted future workload for the worker nodes in the cluster.

Referring back to FIG. 13, at 1310, following collation of the future workload at 1308, the execution planner module 216 may determine whether the profile of the received task is available. The task profile may be read directly from the job profile table 304 or through classification via the job category table 306.

At 1312, if at task profile is available that corresponds to the received task, the execution planner module 216 may use the information in the task profile to determine which of the processing slots may be shared with the received task.

At 1314, on the other hand, if a task profile is not available for the received task, the execution planner module 216 may assume that that task may share the processing slots 128 with any of the currently assigned tasks.

At 1316, after determining all the sharable slots, the execution planer module 216 may select an optimal slot/currently assigned task for sharing processing with the received task. When selecting a slot and currently assigned task, the execution planner module 216 may also take into consideration reserving enough sharable slots for the predicted future workload determined in 1308.

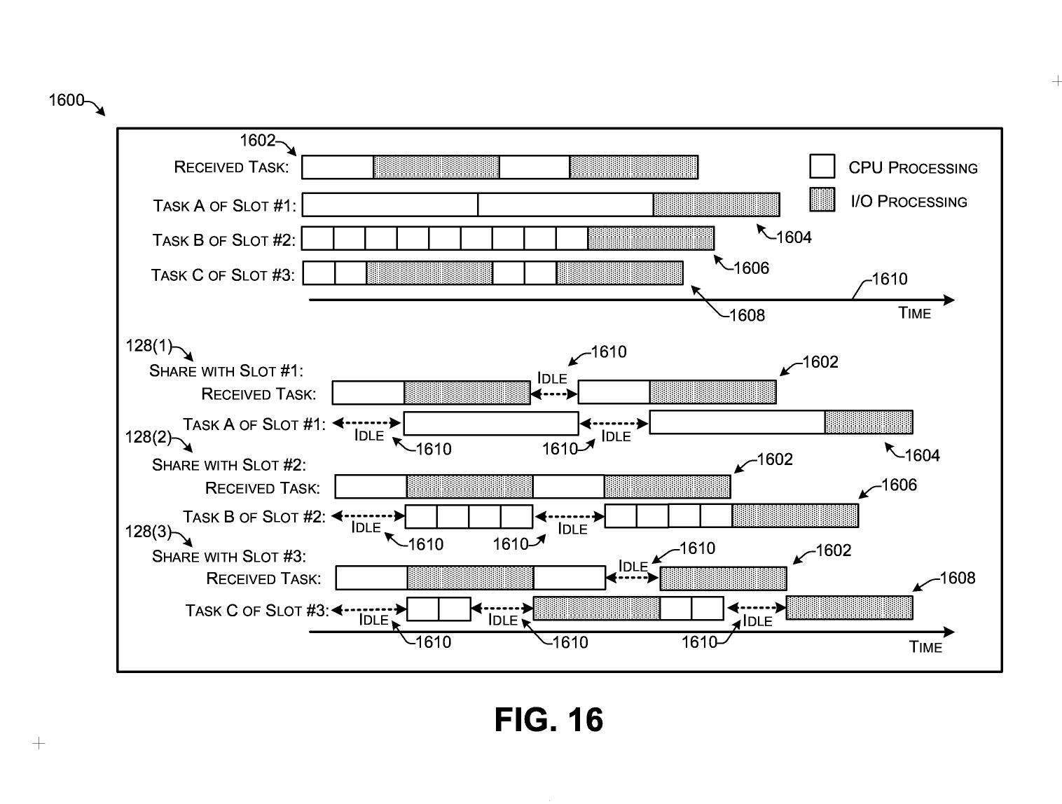

FIG. 16 illustrates an example 1600 of determining an optimal slot and task for sharing processing with the received task according to some implementations. In this example, the task profiles of the currently assigned tasks and the received tasks are known, which permits the determination of which processing slot may be shared for achieving optimal processing efficiency. As one example, the underlying sharing determination may be based, at least in part, on the concept that while one of the tasks sharing a processing slot 128 is performing I/O processing, another task sharing the processing slot may continue execution with CPU processing using the resources designated for the same processing slot 128. Accordingly, implementations herein may include a switching mechanism such that resource usage is switched between two tasks that are sharing the resources of a single processing slot 128, i.e., a first task employs I/O processing while a second task employs CPU processing, and then there is a switch in resource usage so that the first task employs CPU processing and the second task employs I/O processing. This switching may be managed by the task tracker module 118 on each worker node, as discussed additionally below with respect to FIG. 17.

In the illustrated example of FIG. 16, the received task has a task profile 1602 having two CPU processing durations and two I/O durations. Further, there are three processing slots 128(1), 128(2), and 128(3), and all slots are already occupied with some assigned tasks, i.e., task A, task B, and task C, respectively. Task A has a task profile 1604, which includes two I/O segments and a CPU processing segment. Task B has a task profile 1606 that includes nine short I/O segments and one CPU processing segment. Task C has a task profile 1608 that includes two I/O segments, followed by a CPU processing segment, two more I/O segments, and another CPU processing segment.

The composition of the task profiles 1602-1608 may affect the overall running times of the tasks in each slot if sharing is implemented. A comparison of how the received task profile 1602 of the received task matches up with the task profiles 1604-1608 of the tasks A-C shows that matching the task profile 1602 with the task profile 1606 in slot 128(2) may result in shorter execution time for the received task, and shorter overall execution time for both the received task and task B, than would be the case if the received task were to share slot 128(1) with task A or share slot 128(3) with task C. For instance, there is less idle time 1610 if the received task shares slot 128(2) with task B, than is the case if the receive tasks shares a slot with task A or task C. Idle time 1610 occurs where the processing of one task ends before the processing of the other task sharing the slot and/or if both tasks need to perform the same type of processing.

The comparison of the task profile 1602 of the received task with the respective task profiles 1604-1608 of the already assigned tasks A-C can result in a determination of an already assigned task profile that at least partially complements the received task profile 1602, i.e., CPU processing durations of the received task profile 1602 match up with the I/O processing durations of the already assigned task B profile 1606, and/or vice versa. Further, the slot selected for sharing may significantly affect the completion time of the received task, as well as the already assigned task. Therefore, the profile 1602 of the received task and the profiles 1604-1608 of the already assigned tasks can be used to determine if sharing might be counterproductive. For example, if the completion time of “received task plus already assigned task in a shared slot” is close to or greater than the “completion time of the received task” plus the “completion time of the already assigned task” when executed separately, then sharing is not worthwhile, and the particular slot is not considered to be shareable. Accordingly, in some cases, only previously assigned processing slots that can accommodate productive sharing are considered sharable slots.

Referring back to FIG. 13, at 1316, after obtaining all the sharable slots, the execution planer module 216 may select a particular slot based on a comparison of the received task profile with the task profiles of tasks already assigned to each shareable slot. For instance, the selection may be based on finding a task profile of an already assigned task that complements, at least in part, the task profile of the received task, i.e., complements in that at least one CPU processing duration of the received task profile corresponds to an I/O processing duration of the assigned task profile or at least one I/O processing duration of the received task profile corresponds to a CPU processing duration of the assigned task profile.

In addition, when selecting a slot for sharing, the execution planner module 216 may also take into consideration one or more tasks in the predicted future workload determined at block 1308. For example, from the predicted future workload, the execution planner module 216 may determine one or more tasks that may arrive while the received task is still being executed on a selected slot. Accordingly, if these one or more tasks are also prioritized, and if these one or more tasks have task profiles that match up better with the task profiles of particular tasks already assigned to particular slots, then rather than assigning the received task to sharing one of those particular slots, a different slot may be selected for the received task to share to achieve greater overall cluster performance. Thus, when selecting a slot for sharing by the received task, the execution planner module 216 may take into consideration the task profiles of the one or more tasks in the predicted future workload and may reserve enough sharable slots for the predicted future workload.

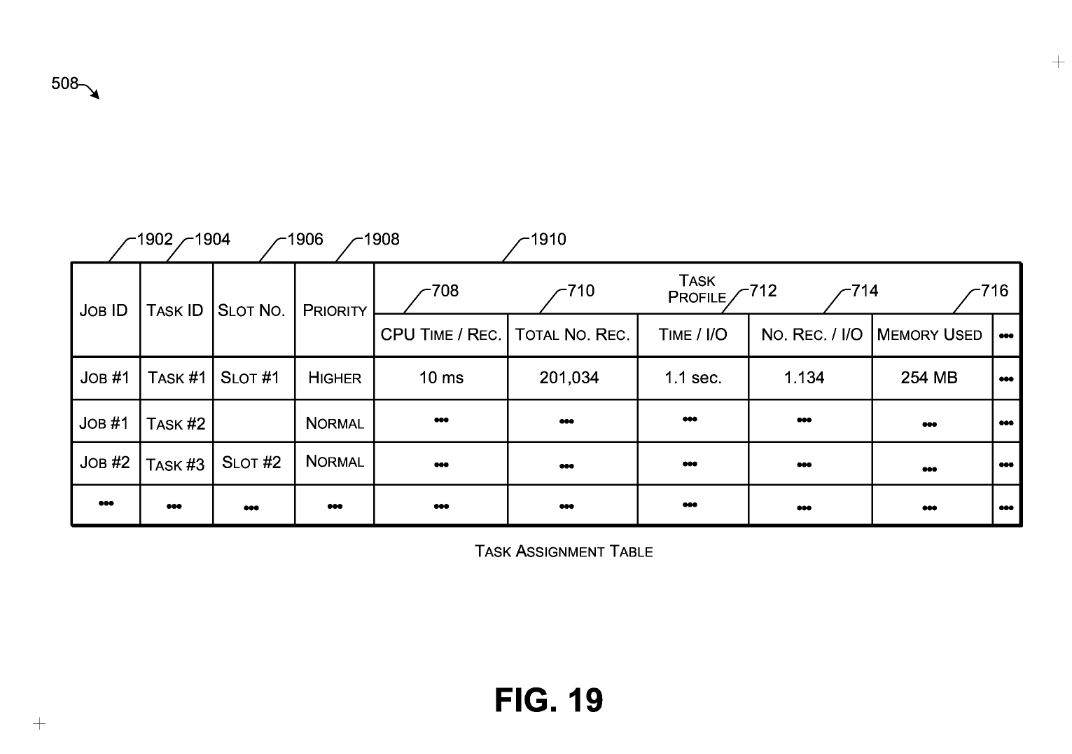

At 1318, when the execution planner module 216 has selected a particular slot to be shared by the received task, the execution planner module 216 may assign the task to the selected slot, such as by sending a communication including task information and slot information to the selected worker node 110. This information may be used by the worker node 110 to update the task assignment table for the worker node 110, as discussed additionally below with respect to FIG. 19.

At 1320, the execution planner module 216 may add the entry of the received task and the selected slot into the resource allocation table 226.

FIG. 17 is a flow diagram illustrating an example process 1700 for execution of an assigned task on a worker node according to some implementations. For example, the process 1700 includes an algorithm structure corresponding to the task tracker module 118 in some examples. As mentioned above, the task tracker module 118 may include one or more instances of the reporter module 502 and the task executor module 504. As one example, the execution of the assigned tasks may be controlled by the task executor module 504 of a processing slot 128 of a worker node 110.

At 1701, the task executor 504 may select from among the assigned tasks, whether to apply a map or reduce function, which may also be referred to herein as the task function in response to receiving a task as an input. For example, execution of a task is subject to the availability of the input data for the respective task and a priority associated with the respective task. This information may be obtained from the buffer readiness table 506 and the task assignment table 508 respectively.

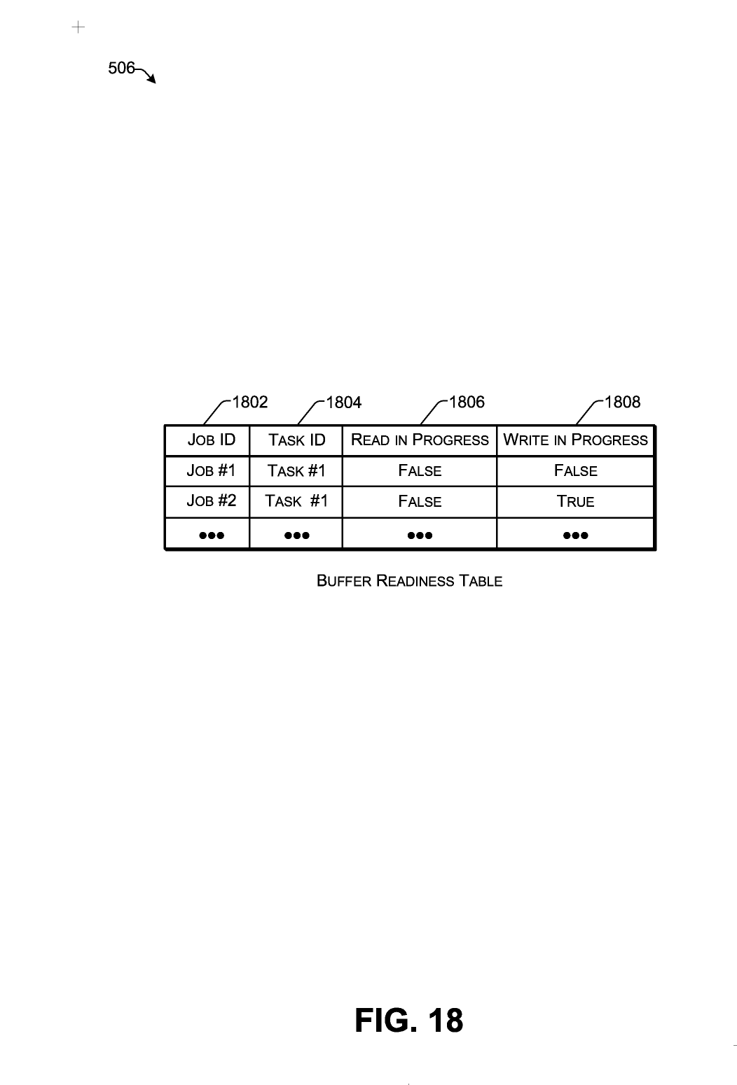

FIG. 18 illustrates an example of a structure of the buffer readiness table 506 according to some implementations. In the illustrated example, the buffer readiness table 506 includes, for each job, a job ID 1802, a task ID 1804, a read in progress indicator 1806, and a write in progress indicator 1808. The job ID 1802 is the cluster-unique ID, or other individually distinguishable ID, that is assigned by the job tracker 108 upon job submission to identify the job. The task ID 1804 is the cluster-unique ID, or other individually distinguishable ID, that is assigned by the job tracker 108 upon job submission of the corresponding job to identify the task. The read in progress indicator 1806 indicates if the input buffer 510 for the task is being used for reading. The write in progress indicator 1808 indicates if the output buffer 512 for the task is being used for writing. Accordingly, the buffer readiness table indicates for particular tasks, whether an input buffer 510 and an output buffer 512 for a particular task are currently in use.

FIG. 19 illustrates an example of a structure of the task assignment table 508 according to some implementations. In the illustrated example, the task assignment table 508 includes, for each listed job, a job ID 1902, a task ID 1904, a slot number 1906, a priority 1908, and a task profile 1910. The job ID 1902 is the cluster-unique ID, or other individually distinguishable ID, assigned by the job tracker 108 upon job submission of the job to identify the job. The task ID 1904 is the cluster-unique ID, or other individually distinguishable ID, assigned by the job tracker 108 upon job submission to identify the task of the job. The slot-number 1906 indicates which processing slot 128 is assigned to be used by this task. The priority 1908 indicates the priority of the task, e.g., normal priority or higher priority, which is higher than normal priority. The values for items 1902-1908 are provided by the job tracker 108 when the task assignment is made at 1318 of FIG. 13. The task profile 1910 follows the format of the task profile in the task profile table 302 in the workflow learning database 228 of the job tracker 108. Thus, the task profile 1910 may include, for each task, a CPU time per record 708, a total number of records 710, a time per I/O 712, a number of records per I/O 714, and an amount of memory used 716. Further, as mentioned above, the task profile is not limited to these parameters, and other parameters may be additionally or alternatively used.

Referring back to FIG. 17, at 1702, the task executor module 504 may select the highest priority task whose input and output buffers are not being used, and may read the selected task for applying the task function. If no tasks are currently assigned, the task executor module 504 may wait until at least one candidate task exists.

At 1704, the task executor module 504 may determine whether the input data corresponding to the selected task is available for reading.

At 1706, if the input buffer for the selected task does not have sufficient data to produce the input for the task function, the task executor module 504 may initiate a read thread to fetch the data into the input buffer. In some implementations, this may involve reading from a local storage device 410 of the worker node for a reduce task and/or reading from one or more data node modules 116 of other worker nodes 110 via the communication interfaces 406 for a map task.

At 1708, the task executor module 504 may set the corresponding read in progress value 1806 in the buffer readiness table 506 as true and return to 1702 to reselect a task. When the read thread at 1706 has completed, the read in progress value 1806 in the buffer readiness table 506 is set back to false, such as by the process controlling the read thread.

At 1710, when the input data for a selected task is available, the task executor module 504 may apply the task function on one or more key/value pairs.

At 1712, the task executor module 504 may collect the task profile information for the task profile 1910 from the task assignment table 508. The reporter module 502 of the processing slot 128 may periodically retrieve all the task profiles 1910 in the task assignment table 508 and send these to the job tracker 108. The profile collector module 222 of the job tracker 108 may receive these task profiles at block 614 of FIG. 6, and this information may be used to update the workflow learning database, as discussed at block 616 of FIG. 6.

At 1714, the task executor module 530 may receive the output of the application of the task function.

At 1716, the task executor module 530 may check if the output buffer has sufficient space to store the output of the task function.

At 1718, if the output buffer does not have sufficient space to store the output, the task executor module 504 may initiate a write thread to flush the output buffer. In some implementations, this may involve writing data in the buffer to a local storage device 410 for map tasks and writing the data in the buffer to a plurality of data node modules 116 via the communication interfaces 406 for reduce tasks.

At 1720, the task executor module 530 may hold the data from the buffer in memory while the write is in progress.

At 1722, the task executor module 504 may set the corresponding write in progress value 1808 in the buffer readiness table 506 as true. Then, the task executor module 530 may continue with selection of another task at 1702.

At 1724, if the output buffer has enough space at 1716, the task executor module 504 may write the output into the output buffer at 1712.

At 1726, the task executor module 530 may check if all the tasks have completed. If there are other tasks remaining, task executor module 530 may return to 1702 and continue processing tasks.

At 1728, if there are no more tasks remaining, the task executor module 504 may flush all the output and end the execution.

In some implementation, if the received job is identified as part of a workflow, as discussed with respect to block 604 above in FIG. 6, with a plurality of succeeding jobs to take its output as their input, the output may be placed optimally in the output buffer or in other local storage in anticipation of the future workload. Additionally, at 1308 of FIG. 13, upon predicting the future workload, the execution planner module 216 may also estimate the future placement of these predicted tasks from 1506 in FIG. 15. This involves the identification of the worker nodes 110 with processing slots 128 that may be able to be shared for determining the advanced placement of tasks anticipated to be received in the near future. This placement may be communicated to the task executor module 504 of the processing slot 128 so that for the reduce tasks, the write thread in 1718 of FIG. 17 may write its output to the data node 116 of the identified worker nodes 110.

The classification algorithm is used by the execution planner module 216 of the job tracker 108 to identify categories of the submitted jobs. Accordingly, this example includes a workflow configuration module 220 in the job tracker 108 for enabling the administrator 132 to use the administrator device 114 to provide human input in training the classification algorithm.

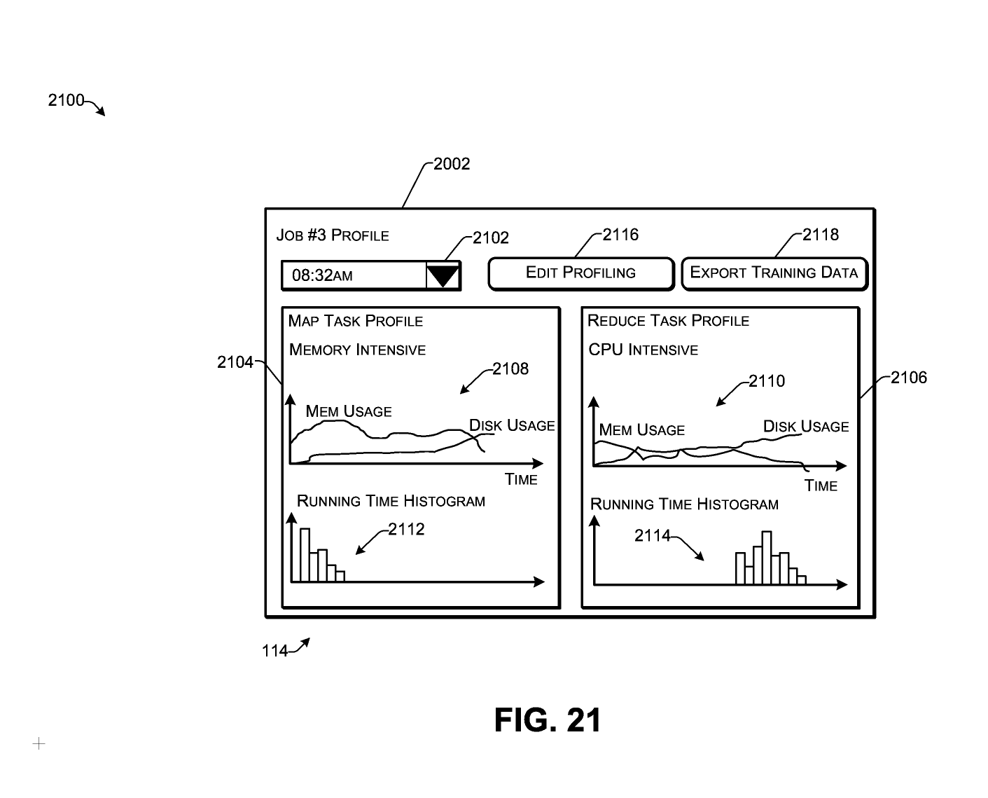

FIGS. 20 and 21 illustrate example user interfaces (UIs) 2000 and 2100, respectively that may be presented on a display 2002 associated with the administrator device 114. The UIs 2000 and 2100 may receive inputs for altering the workflows learned via the workflow learning module 218 in the job tracker 108.

FIG. 20 illustrates the example UI 2000 that may be presented on the display 2002 associated with the administrator device 114 according to some implementations. The UI 2000 may provide a dashboard to enable the administrator 132 to view and alter the identified workflows. The UI 2000 includes a selected workflow window 2004 that may present a graphical representation 2006 of a selected workflow. For instance, a graphical representation 2008 of each job in the workflow is presented along with flow indicators 2010, which indicate which data output from one job is provided to another job in the workflow. The UI 2000 further includes a workflow list 2012 that provides a listing of all workflows in the identified workflow table 310. An add workflow button 2014 may be selected to allow the administrator 132 to add a workflow manually, such as based on the history of submitted jobs in the job profile table 304.

The UI 2000 further includes an export training data button 2016 that allows the administrator 132 to export the data in the workflow learning database 228 into transferable format. In some implementations, this data may be exported into a compressed binary file. The exported data may allow the administrator device 114 to train a new instance by importing the other data via an import training data button 2018.

In the illustrated example, the workflow #1 has been selecting in the workflow list 2012. This selection results in the graphical representation 2006 of workflow #1 being presented in the selected workflow window 2004. The graphical representation 2006 visually shows the interdependence of the jobs 2008 of the selected workflow. In addition, in the selected workflow window 2004, an add job button 2020 enables the administrator 132 to add a job manually to the selected workflow. Further, a delete job button enables the administrator 132 to manually delete a job 2008 from the graphical representation 2006. These buttons 2020, 2022 allows the administrator 132 to alter the workflow from the workflow learned by the workflow learning module 218. Further, as discussed below with respect to FIG. 21, the administrator may select a job representation 2008, which may further allow the administrator 132 to view and alter the job profile of the selected job, such as by manually changing parameters for the selected job in the job profile table 304.

FIG. 21 illustrates the example UI 2100 that may be presented on the display 2002 associated with the administrator device 114 according to some implementations. The UI 2100 may provide a dashboard for the administrator 132 to view and alter the profile of a selected job when the job representation 2008 in FIG. 20 is selected. In the illustrated example, a time-selector 2102 allows the administrator 132 to select the job to view based on the submitted time. A map task profile window 2104 and a reduce task profile window 2106 allow the administrator 132 to view various statistical information of the map and reduce tasks, respectively, of the selected job. In this example, the map task profile and the reduce task profile include graphic representations 2108 and 2110, respectively, of memory usage, disk usage, and the running time, such as may be retrieved from the map task profile 1108 and the reduce-task-profile 1112, respectively, of the job category table 306. Further, the map task profile window 2104 and a reduce task profile window 2106 may include histograms 2112 and 2114, respectively, that are representative of the running times of the respective tasks.

An edit profiling button 2116 allows the administrator 132 to alter the observed profiling based on some human judgment. An export training data button 2118 allows the administrator 132 to export the job profile of this particular job for data importing via the import training data-button 2018 in FIG. 20.

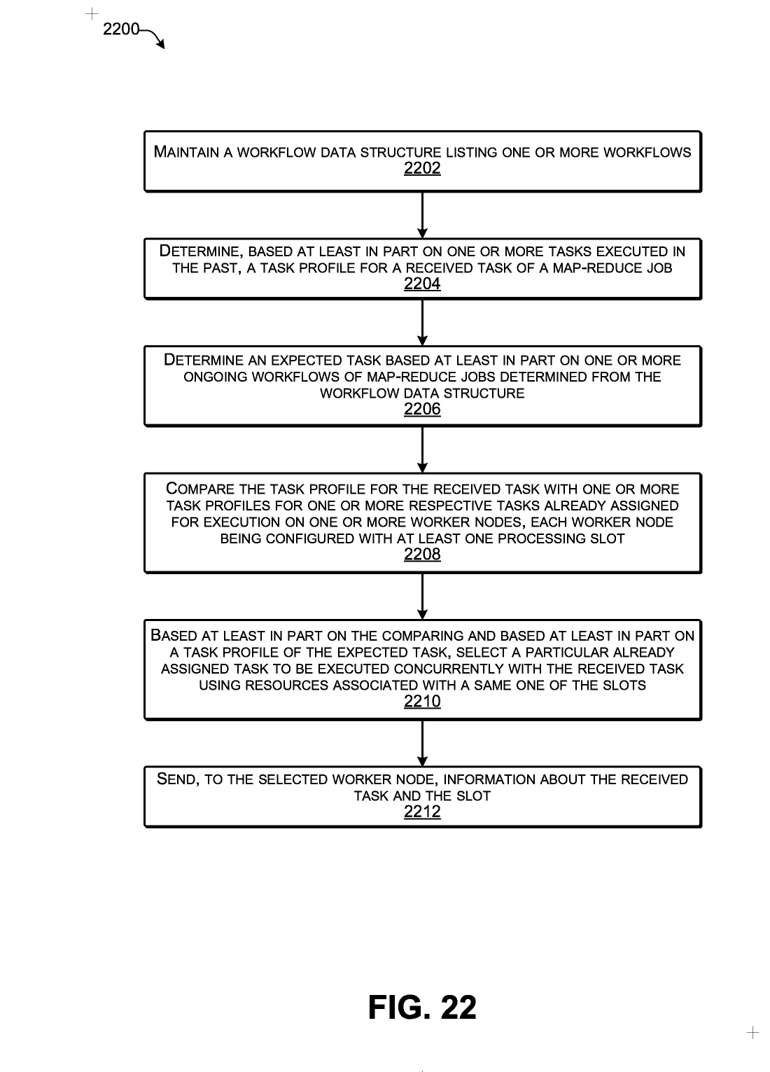

FIG. 22 is a flow diagram that illustrates an example process 2200 for concurrent executing of tasks according to some implementations. In some examples, the process of FIG. 22 provides the structure of an algorithm that is executed by the one or more modules 130 of the job tracker 108.

At 2202, the job tracker may maintain a workflow data structure listing one or more workflows. For instance, the job tracker may maintain the current workflow table 308 that may indicate workflows currently being executed by the worker nodes.

At 2204, the job tracker may determine, based at least in part on one or more tasks executed in the past, a task profile for a received task of a map-reduce job.

At 2206, the job tracker may determine an expected task based at least in part on one or more currently executing ongoing workflows of map-reduce jobs determined from the workflow data structure.

At 2208, the job tracker may compare the task profile for the received task with one or more task profiles for one or more respective tasks already assigned for execution on one or more worker nodes, each worker node being configured with at least one processing slot.

At 2210, based at least in part on the comparing and based at least in part on a task profile of the expected task, the job tracker may select a particular already assigned task to be executed concurrently with the received task using resources associated with a same one of the slots. Thus, the received job may be executed on the same slot as another task that is already assigned to the same slot and that may already have begun execution on that slot. As mentioned above, the job tracker may select the already assigned task based at least in part on in part on the task profile of the received task being complementary, at least in part, to the task profile of the selected task, such as by determining at least one of: processor processing of the received task is predicted to be performed at least in part during input/output (I/O) processing of the selected task; or I/O processing of the received task is predicted to be performed at least in part during processor processing of the selected task. Further, as mentioned above, the job tracker may also take into consideration task profile of an expected task. For example, it the task profile of an expected task better complements a task profile of a particular already assigned task, the job tracker might not assign the received job to that slot, but instead may save the slot to be shared by the expected task and the particular already assigned task.

At 2212, the job tracker may send, to the selected worker node, information about the received task and the slot. Thus, the worker node may proceed with execution of the received task concurrently with the selected task using the resources designated for a single slot.

The example processes described herein are only examples of processes provided for discussion purposes. Numerous other variations will be apparent to those of skill in the art in light of the disclosure herein. Further, while the disclosure herein sets forth several examples of suitable frameworks, architectures and environments for executing the processes, implementations herein are not limited to the particular examples shown and discussed. Furthermore, this disclosure provides various example implementations, as described and as illustrated in the drawings. However, this disclosure is not limited to the implementations described and illustrated herein, but can extend to other implementations, as would be known or as would become known to those skilled in the art.

Various instructions, processes, and techniques described herein may be considered in the general context of computer-executable instructions, such as program modules stored on computer-readable media, and executed by the processor(s) herein. Generally, program modules include routines, programs, objects, components, data structures, etc., for performing particular tasks or implementing particular abstract data types. These program modules, and the like, may be executed as native code or may be downloaded and executed, such as in a virtual machine or other just-in-time compilation execution environment. Typically, the functionality of the program modules may be combined or distributed as desired in various implementations. An implementation of these modules and techniques may be stored on computer storage media or transmitted across some form of communication media.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

1. A system comprising:
one or more processors; and
one or more computer-readable media storing instructions executable by the one or more processors, wherein the instructions program the one or more processors to:
determine a task profile for a received task of a map-reduce job, wherein the task profile includes an indication of predicted processing for the received task;
determine an expected task based at least in part on one or more ongoing workflows of map-reduce jobs;
compare the task profile for the received task with one or more task profiles for one or more respective tasks already assigned for execution on one or more worker nodes, wherein each worker node is configured with at least one processing slot for processing a respective one of the tasks; and
based at least in part on the comparing and based at least in part on a task profile of the expected task, select a particular already assigned task to be executed concurrently with the received task using resources associated with a slot to which the selected task is already assigned.

2. The system as recited in claim 1, wherein the instructions further program the one or more processors to:
maintain a workflow data structure listing one or more workflows, wherein a workflow comprises at least a first map-reduce job that outputs data and at least one second map-reduce job that uses at least a portion of the output data;
determine, from the workflow data structure, a first workflow that includes the map-reduce job corresponding to the received task; and
determine the task profile for the received task based at least in part on the received task being associated with the first workflow.

3. The system as recited in claim 1, wherein the instructions further program the one or more processors to:
determine a job category of the map-reduce job corresponding to the received task; and
determine the task profile for the received task based at least in part on one or more tasks executed in the past for a different map-reduce job classified in a same category as the map-reduce job of the received task.

4. The system as recited in claim 1, wherein the instructions further program the one or more processors to:
maintain a workflow data structure listing one or more workflows, wherein a workflow comprises at least a first map-reduce job that outputs data and at least one second map-reduce job that uses at least a portion of the output data; and
determine the expected task, at least in part, by accessing the workflow data structure listing the one or more workflows, wherein the expected task is a task of a map-reduce job in the one or more workflows.

5. The system as recited in claim 1, wherein the instructions further program the one or more processors to present, on a display, a user interface that includes a graphical representation of a workflow, wherein the workflow comprises at least a first map-reduce job that outputs data and at least one second map-reduce job that uses at least a portion of the output data.

6. The system as recited in claim 5, wherein the instructions further program the one or more processors to:
receive, via the user interface, a selection of one of first map-reduce job or the second map-reduce jobs;
present job profile information related to the selected map-reduce job, wherein the job profile includes one or more processing parameters related to the map-reduce job;
receive, via the user interface, a change to the job profile information related to the select map-reduce job; and
associate the change with the job profile information.

7. The system as recited in claim 1, wherein the instructions further program the one or more processors to select the already assigned task based on the comparing based at least in part on determining at least one of:
a duration of processor processing of the received task is predicted to correspond at least in part to a duration of input/output (I/O) processing of the selected already assigned task during the concurrent execution of the received task and the already assigned task using the resources to which the selected task is already assigned; or
a duration of I/O processing of the received task is predicted to correspond at least in part to a duration of processor processing of the selected already assigned task during the concurrent execution of the received task and the already assigned task using the resources to which the selected task is already assigned.

8. The system as recited in claim 1, wherein the instructions further program the one or more processors to:
determine that input data for the received task is available in a buffer;
execute at least a portion of the received task;
determine task profile information for the received task; and
store output from the received task in an output buffer.

9. The system as recited in claim 1, wherein the instructions further program the one or more processors to determine the task profile for the received task by determining one or more estimated processor processing durations and one or more estimated input/output durations for the received task.

10. A method comprising:
determining, by one or more processors, based at least in part on one or more tasks executed in the past, a task profile for a received task of a map-reduce job, wherein the task profile includes an indication of predicted processing for the received task;
comparing, by the one or more processors, the task profile for the received task with one or more task profiles for one or more respective tasks already assigned for execution on one or more worker nodes, wherein each worker node is configured with at least one processing slot for processing a respective one of the tasks, wherein each processing slot comprises resources reserved on a respective worker node for processing a task; and
based at least in part on the comparing, selecting, by the one or more processors, a particular already assigned task to be executed concurrently with the received task using the resources associated with a same one of the slots to which the particular task is assigned.

11. The method as recited in claim 10, further comprising:
determining an expected task based at least in part on one or more ongoing workflows of map-reduce jobs;
comparing a task profile for the expected task with the one or more task profiles for the one or more respective tasks already assigned for execution on the one or more worker nodes; and
selecting the particular task to be executed concurrently with the received task based at least in part on the comparing the task profile for the expected task with the one or more task profiles for the one or more respective tasks already assigned.

12. The method as recited in claim 11, further comprising:
maintaining a workflow data structure listing one or more workflows, wherein a workflow comprises at least a first map-reduce job that outputs data and at least one second map-reduce job that uses at least a portion of the output data; and
determining the expected task, at least in part, by accessing the workflow data structure listing the one or more workflows, wherein the expected task is a task of a map-reduce job in the one or more workflows.

13. The method as recited in claim 10, further comprising:
maintaining a workflow data structure listing one or more workflows, wherein a workflow comprises at least a first map-reduce job that outputs data and at least one second map-reduce job that uses at least a portion of the output data;
determining, from the workflow data structure, a first workflow that includes the map-reduce job corresponding to the received task; and
determining the task profile for the received task based at least in part on the received task being associated with the first workflow

14. The method as recited in claim 10, further comprising:
in response to receiving the received task, determining that the received task has a higher priority than the one or more respective tasks already assigned for execution on the one or more worker nodes; and
selecting the selected task to be executed concurrently with the received task based at least in part on the received task having a higher priority than the selected task.

15. The method as recited in claim 10, wherein selecting the already assigned task based on the comparing is based at least in part on determining at least one of:
a duration of processor processing of the received task is predicted to correspond at least in part to a duration of input/output (I/O) processing of the selected already assigned task; or
a duration of I/O processing of the received task is predicted to correspond at least in part to a duration of processor processing of the selected already assigned task.

16. One or more non-transitory computer-readable media maintaining instructions that, when executed by one or more processors, program the one or more processors to:
determine a task profile for a received task of a map-reduce job, wherein the task profile includes an indication of predicted processing for the received task;
compare the task profile for the received task with one or more task profiles for one or more respective tasks already assigned for execution on one or more worker nodes, wherein each worker node is configured with at least one processing slot for processing a respective one of the tasks; and
based at least in part on the comparing, select a particular already assigned task to be executed concurrently with the received task using resources associated with a slot to which the particular task is already assigned.

17. The one or more non-transitory computer-readable media as recited in claim 16, wherein the instructions further program the one or more processors to:
determine an expected task based at least in part on one or more ongoing workflows of map-reduce jobs;
compare a task profile for the expected task with the one or more task profiles for the one or more respective tasks already assigned for execution on the one or more worker nodes; and
select the particular task to be executed concurrently with the received task based at least in part on the comparing the task profile for the expected task with the one or more task profiles for the one or more respective tasks already assigned.

18. The one or more non-transitory computer-readable media as recited in claim 17, wherein the instructions further program the one or more processors to:
maintain a workflow data structure listing one or more workflows, wherein a workflow comprises at least a first map-reduce job that outputs data and at least one second map-reduce job that uses at least a portion of the output data; and
determine the expected task, at least in part, by accessing the workflow data structure listing the one or more workflows, wherein the expected task is a task of a map-reduce job in the one or more workflows.

19. The one or more non-transitory computer-readable media as recited in claim 16, wherein the instructions further program the one or more processors to present, on a display, a user interface that includes a graphical representation of a workflow, wherein the workflow comprises at least a first map-reduce job that outputs data and at least one second map-reduce job that uses at least a portion of the output data.

20. The one or more non-transitory computer-readable media as recited in claim 16, wherein the instructions further program the one or more processors to select the already assigned task based on the comparing based at least in part on determining at least one of:
a duration of processor processing of the received task is predicted to correspond at least in part to a duration of input/output (I/O) processing of the selected already assigned task; or
a duration of I/O processing of the received task is predicted to correspond at least in part to a duration of processor processing of the selected already assigned task.
